(19) United States
(12) Patent Application Publication
(10) Pub. No.: US 2026/0341141 A1
(43) Pub. Date: Oct. 29, 2026

(54) HEALTHCARE EXIT DETECTION SYSTEM

(71) Applicant: Stryker Corporation, Portage, MI (US)

(72) Inventor: Richard C. Mayoras, Jr., Kalamazoo, MI (US)

(21) Appl. No.: 19/654,908

(22) Filed: Apr. 22, 2026

Related U.S. Application Data
(60) Provisional application No. 63/793,696, filed on Apr. 24, 2025.

(51) Int. Cl. G08B 21/04; A61G 7/05

(52) U.S. Cl. CPC G08B 21/0461; A61G 7/0527; A61G 2200/32; A61G 2203/20; A61G 2203/44

(57) ABSTRACT

A healthcare facility system includes a patient support apparatus and a remote exit detection system. The patient support apparatus includes a local exit detection system that may be independent of the remote exit detection system. The remote exit detection system may issue a remote exit alert when a patient exits from a patient support apparatus that is independent of the settings of the local exit detection system, or vice versa. In some versions, the remote exit detection system may be configurable by a user to respond in selectable manners depending upon whether the local exit detection system or the remote exit detection system detects a patient exit. Still further, in some examples, the exiting of a patient who weighs more than a threshold amount from the patient support apparatus may cause the local and/or remote exit detection system to summon more than one person to assist the exited patient.

### CROSS-REFERENCE TO RELATED APPLICATIONS

This application claims priority to U.S. provisional patent application Ser. No. 63/793,696 filed Apr. 24, 2025, by inventor Richard Mayoras and entitled HEALTHCARE EXIT DETECTION SYSTEM, the complete disclosure of which is incorporated herein by reference.

### BACKGROUND

The present disclosure relates to systems and methods for detecting and/or responding to exit alerts issued in response to a patient exiting from a patient support apparatus, such as a bed, stretcher, cot, or the like.

### SUMMARY

According to various aspects of the present disclosure, a system for detecting and/or responding to a patient's exit from a patient support apparatus is disclosed. The system may include both a local exit detection system that is installed on, or at, the patient support apparatus itself, as well as a remote exit detection system that is positioned remotely (e.g. out of the room) from the patient support apparatus. The remote exit detection system may operate independently from the local exit detection system, or it may be configurable by the user to operate partially, or wholly, in tandem with the local exit detection system. The remote exit detection system may be armed remotely (i.e. away from the patient support apparatus), may utilize a different sensitivity level from the local exit detection system, may issue alerts in a manner different from the local exit detection system, may utilize the same or different sensors than the local exit detection system, and/or may operate the same as, or differently, from the local exit detection system. In some versions, the system may issue alerts in different manners depending upon the weight of the patient wherein, if the patient weighs more than a threshold, at least two caregivers are notified of the patient's exit, thereby helping to ensure sufficient caregivers are summoned to help the patient move. These and other features of the present disclosure will be apparent to one of ordinary skill in the art in light of the following description and accompanying drawings.

According to one aspect of the present disclosure, a system for a healthcare facility comprising a patient support apparatus and a remote exit detection system is provided. The patient support apparatus comprises a support surface adapted to support a patient thereon; a sensor adapted to detect a position of the patient; a local exit detection system adapted to be armed and disarmed; a first control; and a transceiver. The local exit detection system is adapted to process signals from the sensor; to issue a local alert when the patient exits the support surface while the local exit detection system is armed; and to not issue the local alert when the patient exits the support surface while the local exit detection system is disarmed. The first control is adapted to arm the local exit detection system but not the remote exit detection system when activated by a user. The transceiver is adapted to transmit the signals from the sensor to the remote exit detection system. The remote exit detection system comprises a software application embodied in a non-transitory computer readable medium and adapted, when executed by a processor of a computing device, to instruct the computing device to perform the following: (i) detect a state of a second control adapted to arm the remote exit detection system but not the local exit detection system when activated by a user; (ii) detect a state of a third control adapted to be set by the user in a first state or a second state; (iii) process the signals from the sensor; (iv) issue a remote alert when the patient exits the support surface while the remote exit detection system is armed, regardless of the armed or disarmed state of the local exit detection system; (v) issue the remote alert when the patient exits the support surface while the remote exit detection system is disarmed and both of the following are true: the local exit detection system is armed and the third control is in the first state; (vi) not issue the remote alert when the patient exits the support surface while the remote exit detection system is disarmed and both of the following are true: the local exit detection system is armed and the third control is in the second state; and (vii) not issue the remote alert when the patient exits the support surface while both the remote exit detection system and the local exit detection system are disarmed.

According to another aspect of the present disclosure, a system for a healthcare facility comprising a patient support apparatus and a remote exit detection system is provided. The patient support apparatus comprises a support surface adapted to support a patient thereon; a sensor adapted to detect a position of the patient; a local exit detection system adapted to be armed and disarmed; a first control; and a transceiver. The local exit detection system is adapted to process signals from the sensor; to issue a local alert when the patient exits the support surface while the local exit detection system is armed; and to not issue the local alert when the patient exits the support surface while the local exit detection system is disarmed. The first control is adapted to arm the local exit detection system but not the remote exit detection system when activated by a user. The transceiver is adapted to transmit the signals from the sensor to the remote exit detection system. The remote exit detection system comprises a software application embodied in a non-transitory computer readable medium and adapted, when executed by a processor of a computing device, to instruct the computing device to perform the following: (i) detect a state of a second control adapted to arm the remote exit detection system but not the local exit detection system when activated by a user; (ii) process the signals from the sensor; (iii) issue a remote alert when the patient exits the support surface while the remote exit detection system is armed, regardless of the armed or disarmed state of the local exit detection system; and (iv) not issue the remote alert when the patient exits the support surface while the remote exit detection system is disarmed regardless of the armed or disarmed state of the local exit detection system.

According to other aspects of the present disclosure, the sensor comprises a plurality of load cells adapted to detect a weight of the patient while the patient is positioned on the support surface.

In some aspects, both the local exit detection system and the remote exit detection system are adapted to calculate a center of gravity of the patient.

The patient support apparatus, in some aspects, includes a first sensitivity control adapted to allow the user to select a sensitivity level for the local exit detection system. The software application is adapted, when executed by the processor of the computing device, to instruct the computing device to detect a state of a second sensitivity control, wherein the second sensitivity control is adapted to allow the user to select a second sensitivity level for the remote exit detection system. The second sensitivity level may be different from the first sensitivity level.

In some aspects, the patient support apparatus includes a siderail adapted to be moved between a lowered position and a raised position. The local exit detection is adapted to take into account a position of the siderail when issuing the local alert and the remote exit detection system is adapted to not take into account the position of the siderail when issuing the remote alert.

In some aspects, the patient support apparatus includes a siderail adapted to be moved between a lowered position and a raised position. The remote exit detection is adapted to take into account a position of the siderail when issuing the remote alert and the local exit detection system is adapted to not take into account the position of the siderail when issuing the local alert.

In some aspects, the local exit detection system is adapted to take into account a first set of criteria when determining whether to issue the local alert and the remote exit detection system is adapted to take into account a second set of criteria when determining whether to issue the remote alert. The second set of criteria is adjustable by a user.

In some aspects, the local exit detection system is adapted to take into account a first set of criteria when determining whether to issue the local alert and the remote exit detection system is adapted to take into account a second set of criteria when determining whether to issue the remote alert, wherein the second set of criteria is different from the first set of criteria.

The local alert, in some aspects, includes at least one of the following: (1) issuing an aural sound from the patient support apparatus, or (2) flashing a light on the patient support apparatus.

The remote alert, in some aspects, includes at least one of the following: (1) issuing a sound from a speaker communicatively coupled to the computing device, (2) flashing an icon on a display in communication with the computing device, or (3) changing a color of the icon on the display.

The transceiver, in some aspects, is adapted to transmit a local alert message to the remote exit detection system when the local exit detection system issues the local alert.

The remote exit detection system, in some aspects, is adapted to respond to the local alert message by performing at least one of the following: issuing a first sound from a speaker communicatively coupled to the computing device, (2) flashing a first icon on a display in communication with the computing device, or (3) illuminate the first icon in a first color.

The remote exit detection system, in some aspects, is adapted to perform at least one of the following when issuing the remote alert: (1) issue a second sound from the speaker, (2) flash a second icon on the display, or (3) illuminate the second icon in a second color.

In some aspects, at least one of the following is true: (1) the first sound is different from the second sound, (2) the second icon is different from the first icon, or (3) the first color is different from the second color.

In some aspects, the local exit detection system is adapted to issue the local alert when the patient's center of gravity moves outside of a first zone and the remote exit detection system is adapted to issue the remote alert when the patient's center of gravity moves outside of a second zone.

In some aspects, the second zone is different from the first zone.

The remote exit detection system, in some aspects, is adapted to allow the user to select the second zone from amongst a plurality of zones.

The remote exit detection system, in some aspects, is adapted to pause the remote alert without pausing the local alert in response to a user activating a remote pause control.

In some aspects, the local exit detection system is adapted to transmit a weight of the patient to the remote exit detection system, and the remote exit detection system is adapted to use the weight of the patient to determine how to issue the remote alert.

The remote exit detection system, in some aspects, is adapted to transmit the remote alert to multiple individuals if the patient weight exceeds a threshold weight, and to transmit the remote alert to a single individual if the patient weight does not exceed the threshold weight.

In some aspects, the software application is adapted to instruct the computing device to display a dashboard screen on a display associated with the computing device, to issue the remote alert on the dashboard screen in a first manner when the remote exit detection system is armed, and to issue the remote alert on the dashboard screen in a second manner when the remote exit detection system is disarmed, the first manner being different from the second manner.

In some aspects, the first manner includes displaying an icon in a first color and the second manner includes displaying the icon in a second color different from the first color.

According to another aspect of the present disclosure, a system for a healthcare facility is provided that includes a patient support apparatus and a software application embodied in a non-transitory computer readable medium. The patient support apparatus comprises: a support surface adapted to support a patient thereon; a sensor adapted to detect a position of the patient; a local exit detection system adapted to be armed and disarmed; a first control adapted to arm the local exit detection system when activated by a user; and a transceiver adapted to transmit a local alert message to the software application. The local exit detection system is adapted to process signals from the sensor; to issue a local alert when the patient exits the support surface while the local exit detection system is armed; and to not issue the local alert when the patient exits the support surface while the local exit detection system is disarmed. The software application is adapted, when executed by a processor of a computing device, to instruct the computing device to perform the following: (i) receive a patient weight; (ii) compare the patient weight to a threshold; (iii) if the patient weight is less than the threshold, forward an alert message to a single caregiver; and (iv) if the patient weight is greater than the threshold, forward the alert message to a plurality of caregivers.

According to other aspects of the present disclosure, the software application is adapted to instruct the computing device to receive the patient weight from a scale system of the patient support apparatus.

In some aspects, the software application is adapted to instruct the computing device to receive the patient weight from an electronic health records server in communication with the computing device.

The software application, in some aspects, is adapted to instruct the computing device to forward the alert message to the single caregiver by transmitting a message to a particular badge associated with the single caregiver.

In some aspects, the software application is adapted to instruct the computing device to forward the alert message to the plurality of caregivers by transmitting a message to a plurality of badges associated with the plurality of caregivers.

The software application, in some aspects, is adapted to instruct the computing device to receive a user-selected value for the threshold.

The software application, in some aspects, is adapted to instruct the computing device to display a dashboard screen on a display associated with the computing device, to issue an exit alert on the dashboard screen in a first manner in response to forwarding the alert message to a single caregiver, and to issue the exit alert on the dashboard screen in a second manner in response to forwarding the alert message to the plurality of caregivers. The first manner is different from the second manner.

In some aspects, the first manner includes displaying an icon in a first color on the dashboard screen and the second manner includes displaying the icon on the dashboard screen in a second color different from the first color.

The software application, in some aspects, is adapted to instruct the computing device to implement a remote exit detection system adapted to detect a state of a second control. The second control is adapted to arm the remote exit detection system but not the local exit detection system when activated by a user. The remote exit detection system is adapted to issue a remote alert when the patient exits the support surface while the remote exit detection system is armed.

In some aspects, the remote exit detection system is adapted to issue the remote alert when the patient exits the support surface regardless of the armed or disarmed state of the local exit detection system.

The transceiver, in some aspects, is adapted to transmit the signals from the sensor to the remote exit detection system and the remote exit detection system is adapted to process the signals from the sensor in order to determine whether to issue the remote alert.

In some aspects, the software application is adapted to instruct the computing device to perform the following: detect a state of a third control adapted to be set by the user in a first state or a second state; issue the remote alert when the patient exits the support surface while the remote exit detection system is disarmed and both of the following are true: the local exit detection system is armed and the third control is in the first state; (c) not issue the remote alert when the patient exits the support surface while the remote exit detection system is disarmed and both of the following are true: the local exit detection system is armed and the third control is in the second state; and not issue the remote alert when the patient exits the support surface while both the remote exit detection system and the local exit detection system are disarmed.

The sensor, in some aspects, comprises a plurality of load cells adapted to detect a weight of the patient while the patient is positioned on the support surface.

In some aspects, both the local exit detection system and the remote exit detection system are adapted to calculate a center of gravity of the patient.

The patient support apparatus, in some aspects, includes a first sensitivity control adapted to allow the user to select a sensitivity level for the local exit detection system, and the software application is adapted, when executed by the processor of the computing device, to instruct the computing device to detect a state of a second sensitivity control. The second sensitivity control is adapted to allow the user to select a second sensitivity level for the remote exit detection system that may be different from the first sensitivity level.

In some aspects, the patient support apparatus includes a siderail adapted to be moved between a lowered position and a raised position, and the local exit detection is adapted to take into account a position of the siderail when issuing the local alert, but the remote exit detection system is adapted to not take into account the position of the siderail when issuing the remote alert.

In some aspects, the patient support apparatus includes a siderail adapted to be moved between a lowered position and a raised position, and the remote exit detection is adapted to take into account a position of the siderail when issuing the remote alert, but the local exit detection system is adapted to not take into account the position of the siderail when issuing the local alert.

In some aspects, the local exit detection system is adapted to take into account a first set of criteria when determining whether to issue the local alert and the remote exit detection system is adapted to take into account a second set of criteria when determining whether to issue the remote alert. The second set of criteria is adjustable by a user.

In some aspects, the local exit detection system is adapted to take into account a first set of criteria when determining whether to issue the local alert and the remote exit detection system is adapted to take into account a second set of criteria when determining whether to issue the remote alert. The second set of criteria is different from the first set of criteria.

The local alert, in some aspects, includes at least one of the following: (1) issuing an aural sound from the patient support apparatus, or (2) flashing a light on the patient support apparatus.

The remote alert, in some aspects, includes at least one of the following: (1) issuing a sound from a speaker communicatively coupled to the computing device, (2) flashing an icon on a display in communication with the computing device, or (3) changing a color of the icon on the display.

The transceiver, in some aspects, is adapted to transmit a local alert message to the remote exit detection system when the local exit detection system issues the local alert.

The remote exit detection system, in some aspects, is adapted to respond to the local alert message by performing at least one of the following: issuing a first sound from a speaker communicatively coupled to the computing device, (2) flashing a first icon on a display in communication with the computing device, or (3) illuminate the first icon in a first color.

The remote exit detection system, in some aspects, is adapted to perform at least one of the following when issuing the remote alert: issue a second sound from the speaker, (2) flash a second icon on the display, or (3) illuminate the second icon in a second color.

In some aspects, at least one of the following is true: (1) the first sound is different from the second sound, (2) the second icon is different from the first icon, or (3) the first color is different from the second color.

In some aspects, the local exit detection system is adapted to issue the local alert when the patient's center of gravity moves outside of a first zone and the remote exit detection system is adapted to issue the remote alert when the patient's center of gravity moves outside of a second zone.

The second zone, in some aspects, is different from the first zone.

The remote exit detection system, in some aspects, is adapted to allow the user to select the second zone from amongst a plurality of zones.

The remote exit detection system, in some aspects, is adapted to pause the remote alert without pausing the local alert in response to a user activating a remote pause control.

According to another aspect of the present disclosure, a system for a healthcare facility is provided that includes a patient support apparatus and a remote exit detection system. The patient support apparatus includes a support surface adapted to support a patient thereon; a first sensor adapted to detect a position of the patient; a local exit detection system adapted to be armed and disarmed; a first control adapted to arm the local exit detection system but not the remote exit detection system when activated by a user; and a transceiver adapted to transmit a message indicating when the patient has exited the support surface. The local exit detection system is also adapted to process first signals from the first sensor; to issue a local alert when the patient exits the support surface while the local exit detection system is armed; and to not issue the local alert when the patient exits the support surface while the local exit detection system is disarmed. The remote exit detection system comprises a second sensor and a software application. The software application is embodied in a non-transitory computer readable medium and adapted, when executed by a processor of a computing device, to instruct the computing device to perform the following: process second signals from the second sensor to determine when the patient exits the support surface; receive the message from the patient support apparatus; receive a first user input instructing the computing device how to respond to receipt of the first message; and receive a second user input instructing the computing device how to respond to the determination made from the processing of the second signals that the patient has exited the support surface.

According to other aspects of the present disclosure, the first user input may be different from the second user input.

In some aspects, the software application is adapted to instruct the computing device to display a dashboard screen on a display associated with the computing device, to issue an alert on the dashboard screen in a first manner according to the first user input, and to issue the alert on the dashboard in a second manner according to the second user input. The first manner is different from the second manner.

In some aspects, the software application is adapted to instruct the computing device to communicate with a plurality of caregiver badges, to transmit a first message in response to the first user input, and to transmit a second message in response to the second user input, the first message being different from the second message.

The first sensor, in some aspects, includes a plurality of load cells adapted to detect a weight of the patient while the patient is positioned on the support surface.

The second sensor, in some aspects, includes a video camera adapted to detect images of the patient support apparatus.

The local exit detection system, in some aspects, is adapted to calculate a center of gravity of the patient.

In some aspects, the patient support apparatus includes a first sensitivity control adapted to allow the user to select a sensitivity level for the local exit detection system, and the software application is adapted, when executed by the processor of the computing device, to instruct the computing device to detect a state of a second sensitivity control. The second sensitivity control is adapted to allow the user to select a second sensitivity level for the remote exit detection system. The second sensitivity level may be different from the first sensitivity level.

In some aspects, the patient support apparatus includes a siderail adapted to be moved between a lowered position and a raised position, the local exit detection is adapted to take into account a position of the siderail when issuing the local alert, and the remote exit detection system is adapted to not take into account the position of the siderail when processing the second signals from the second sensor.

In some aspects, the patient support apparatus includes a siderail adapted to be moved between a lowered position and a raised position, the remote exit detection is adapted to take into account a position of the siderail when processing the second signals from the second sensor, and the local exit detection system is adapted to not take into account the position of the siderail when issuing the local alert.

In some aspects, the local exit detection system is adapted to take into account a first set of criteria when determining whether to issue the local alert and the remote exit detection system is adapted to take into account a second set of criteria when processing the second signals from the second sensor. The second set of criteria is adjustable by a user.

In some aspects, the local exit detection system is adapted to take into account a first set of criteria when determining whether to issue the local alert and the remote exit detection system is adapted to take into account a second set of criteria when processing the second signals from the second sensor. The second set of criteria may be different from the first set of criteria.

The local alert, in some aspects, includes at least one of the following: (1) issuing an aural sound from the patient support apparatus, or (2) flashing a light on the patient support apparatus.

The first input, in some aspects, causes the computing device to perform at least one of the following: (1) issue a sound from a speaker communicatively coupled to the computing device, (2) flash an icon on a display in communication with the computing device, or (3) change a color of the icon on the display.

In some aspects, the remote exit detection system is adapted to respond to the message by performing at least one of the following: issuing a first sound from a speaker communicatively coupled to the controller, (2) flashing a first icon on a display in communication with the controller, or (3) illuminate the first icon in a first color.

In some aspects, the remote exit detection system is adapted to perform at least one of the following when responding to the determination made from processing of the second signals that the patient has exited the support surface: (1) issue a second sound from the speaker, (2) flash a second icon on the display, or (3) illuminate the second icon in a second color.

In some aspects, at least one of the following is true: (1) the first sound is different from the second sound, (2) the second icon is different from the first icon, or (3) the first color is different from the second color.

In some aspects, the local exit detection system is adapted to issue the local alert when the patient's center of gravity moves outside of a first zone and the remote exit detection system is adapted to issue a remote alert when the patient's center of gravity moves outside of a second zone.

The second zone, in some aspects, is different from the first zone.

In some aspects, the remote exit detection system is adapted to allow the user to select the second zone from amongst a plurality of zones.

In some aspects, the local exit detection system is adapted to transmit a weight of the patient to the remote exit detection system, and the remote exit detection system is adapted to use the weight of the patient to determine how to issue a remote alert.

The remote exit detection system, in some aspects, is adapted to transmit the remote alert to multiple individuals if the patient weight exceeds a threshold weight, and to transmit the remote alert to a single individual if the patient weight does not exceed the threshold weight.

Before the various versions disclosed herein are explained in detail, it is to be understood that the claims are not to be limited to the details of operation or to the details of construction and the arrangement of the components set forth in the following description or illustrated in the drawings. The versions described herein are capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various versions. Unless otherwise expressly stated, the use of enumeration should not be construed as limiting the claims to any specific order or number of components. Nor should the use of enumeration be construed as excluding from the scope of the claims any additional steps or components that might be combined with or into the enumerated steps or components.

### BRIEF DESCRIPTION OF THE DRAWINGS

FIG. 1 is a perspective view of one example of a patient support apparatus that may be used with the system of the present disclosure;

FIG. 2 is a perspective view of a litter frame of the patient support apparatus;

FIG. 3 is a perspective view of a base of the patient support apparatus;

FIG. 4 is a plan view of a control panel that may be included with the patient support apparatus;

FIG. 5 is a selection screen for selecting a sensitivity level of a local exit detection system that may be displayed on the display of FIG. 4;

FIG. 6 is a block diagram of a management system according to aspects of the present disclosure;

FIG. 7 is a selection screen for changing configuration settings of a remote exit detection system that may be displayed on a screen that is in communication with the remote exit detection system; and

FIG. 8 is a plan view of a dashboard screen that may be displayed on a screen that is in communication with the remote exit detection system.

### DETAILED DESCRIPTION

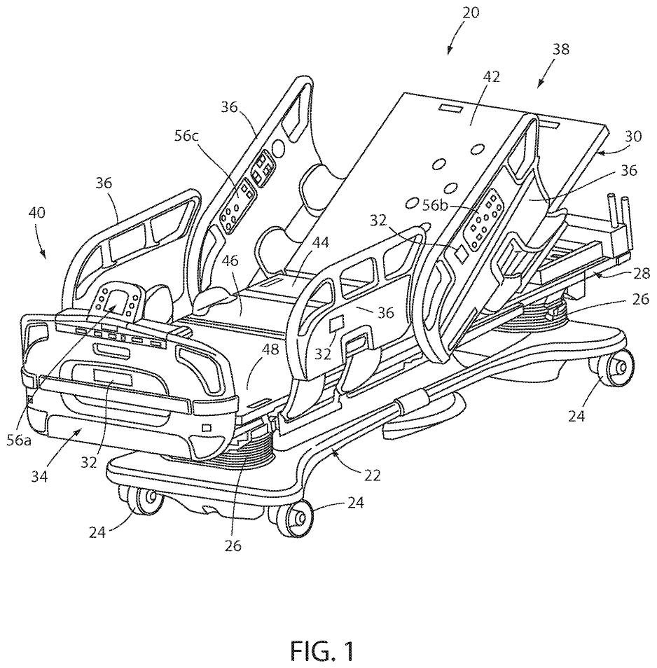

An illustrative patient support apparatus 20 that may be used in a remote exit detection management system of the present disclosure is shown in FIG. 1. Although the particular form of patient support apparatus 20 illustrated in FIG. 1 is a bed adapted for use in a hospital or other medical setting, it will be understood that patient support apparatus 20 could, in different versions, be a cot, a stretcher, a recliner, or any other structure capable of supporting a patient in a healthcare environment.

In general, patient support apparatus 20 includes a base 22 having a plurality of wheels 24, a pair of lifts 26 supported on the base 22, a litter frame 28 supported on the lifts 26, and a support deck 30 supported on the litter frame 28. Patient support apparatus 20 further includes a removable headboard (not shown), a removable footboard 34 and a plurality of siderails 36. Siderails 36 are all shown in a raised position in FIG. 1 but are each individually movable to a lower position in which ingress into, and egress out of, patient support apparatus 20 is not obstructed by the lowered siderails 36.

Lifts 26 are adapted to raise and lower litter frame 28 with respect to base 22. Lifts 26 may utilize hydraulic actuators, electric actuators, or any other suitable device for raising and lowering litter frame 28 with respect to base 22. In the illustrated version of patient support apparatus 20, lifts 26 are operable independently so that the tilting of litter frame 28 with respect to base 22 can also be adjusted, to place the litter frame 28 in a flat or horizontal orientation, a Trendelenburg orientation, or a reverse Trendelenburg orientation. That is, litter frame 28 includes a head end 38 and a foot end 40, each of whose height can be independently adjusted by the nearest lift 26. Patient support apparatus 20 is designed so that when an occupant lies thereon, his or her head will be positioned adjacent head end 38 and his or her feet will be positioned adjacent foot end 40. The lifts 26 may be constructed and/or operated in any of the manners disclosed in commonly assigned U.S. patent publication 2017/0246065, filed on Feb. 22, 2017, entitled LIFT ASSEMBLY FOR PATIENT SUPPORT APPARATUS, the complete disclosure of which is hereby incorporated herein by reference. Other manners for constructing and/or operating lifts 26 may, of course, be used.

Litter frame 28 provides a structure for supporting support deck 30, the headboard, footboard 34, and siderails 36. Support deck 30 provides a support surface for a mattress (not shown), or other soft cushion, so that a person may lie and/or sit thereon. Support deck 30 is made of a plurality of sections, some of which are pivotable about generally horizontal pivot axes. In the example shown in FIG. 1, support deck 30 includes at least a head section 42, a seat section 44, a thigh section 46, and a foot section 48, all of which generally form flat surfaces for supporting a mattress. Head section 42, which is also sometimes referred to as a Fowler section, is pivotable about a generally horizontal pivot axis between a generally horizontal orientation (not shown in FIG. 1) and a plurality of raised positions (one of which is shown in FIG. 1). Seat section 44, thigh section 46, and/or foot section 48 may also be pivotable about generally horizontal pivot axes.

Patient support apparatus 20 may include one or more visual identifiers 32. Visual identifiers 32 may be any visually distinguishing marking on patient support apparatus 20 that distinguishes a particular patient support apparatus 20 from other patient support apparatuses 20 that are present within the healthcare facility. For example, visual identifiers 32 may include a Quick Response (QR) code, a bar code, a serial number, or any other type of identifier that is visually detectable (i.e. by one or more cameras 64, as will be discussed further below) and that uniquely identifies the particular patient support apparatus 20 it is attached to, or built into, or otherwise marked by. In the example shown in FIG. 1, visual identifier 32 is shown coupled to a siderail 36, but it will be understood that visual identifier 32 may be moved to other locations on patient support apparatus 20. In some versions, patient support apparatus 20 may include multiple visual identifiers 32 may be positioned at different locations on patient support apparatus 20 so that at least one visual identifier 32 will be visible to a camera 64 no matter how patient support apparatus 20 is oriented or positioned, and/or no matter where camera(s) 64 are positioned, at locations within a healthcare facility. In some versions, the visual identifier may be temporarily or permanently displayed on a display of the patient support apparatus 20. In other versions, visual identifiers 32 may be omitted and the location of a patient support apparatus 20 within a healthcare facility may be determined without the use of one or more cameras 64.

It will be understood by those skilled in the art that patient support apparatus 20 can be designed with other types of mechanical constructions, such as, but not limited to, that described in commonly assigned, U.S. Pat. No. 10,130,536 to Roussy et al., entitled PATIENT SUPPORT USABLE WITH BARIATRIC PATIENTS, the complete disclosure of which is incorporated herein by reference. As another example, the mechanical construction of patient support apparatus 20 may be the same as, or nearly the same as, the mechanical construction of the Model 3002 S3 bed manufactured and sold by Stryker Corporation of Kalamazoo, Michigan. This mechanical construction is described in greater detail in the Stryker Maintenance Manual for the MedSurg Bed, Model 3002 S3, published in 2010 by Stryker Corporation of Kalamazoo, Michigan, the complete disclosure of which is incorporated herein by reference. It will be understood by those skilled in the art that patient support apparatus 20 can be designed with still other types of mechanical constructions, such as, but not limited to, those described in commonly assigned, U.S. Pat. No. 7,690,059 issued to Lemire et al., and entitled HOSPITAL BED; and/or commonly assigned U.S. Pat. publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosures of both of which are also hereby incorporated herein by reference. The mechanical construction of patient support apparatus 20 may also take on still other forms different from what is disclosed in the aforementioned references.

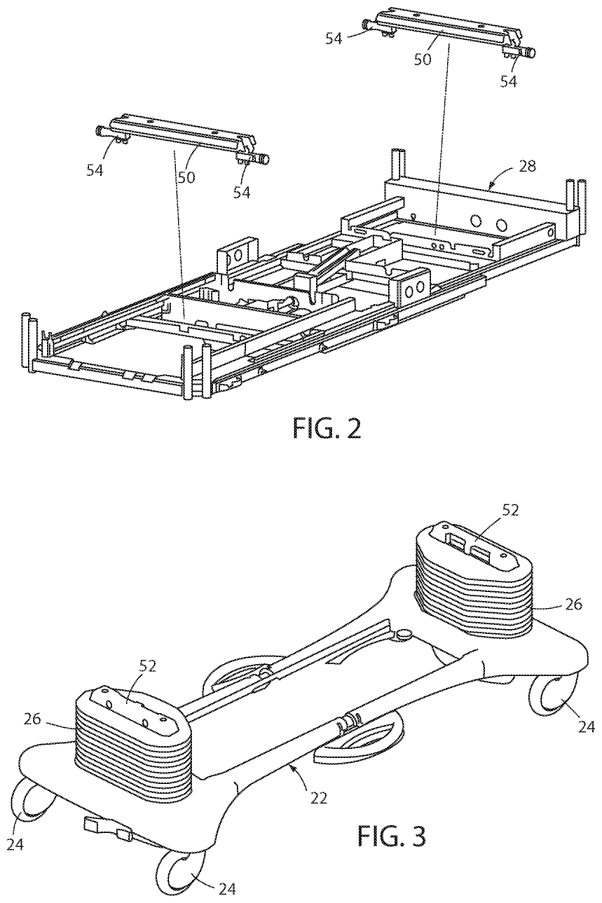

FIG. 2 illustrates in greater detail litter frame 28 separated from lifts 26 and base 22. Litter frame 28 is also shown in FIG. 2 with support deck 30 removed. Litter frame 28 is supported by two lift header assemblies 50. A first one of the lift header assemblies 50 is coupled to a top 52 (FIG. 3) of a first one of the lifts 26, and a second one of the lift header assemblies 50 is coupled to the top 52 of the second one of the lifts 26. Each lift header assembly 50 includes a pair of force sensors 54, which may be load cells, or other types of force sensors. The illustrated version of patient support apparatus 20 therefore includes a total of four force sensors 54, although it will be understood by those skilled in the art that different numbers of force sensors may be used in accordance with the principles of the present disclosure. Force sensors 54 are configured to support litter frame 28. More specifically, force sensors 54 are configured such that they provide complete and exclusive mechanical support for litter frame 28 and all of the components that are supported on litter frame 28 (e.g. support deck 30, footboard 34, the headboard, siderails 36, etc.). Because of this construction, force sensors 54 are adapted to detect the weight of not only those components of patient support apparatus 20 that are supported by litter frame 28 (including litter frame 28 itself), but also any objects or persons who are wholly or partially being supported by support deck 30. The outputs of force sensors 54 are used for implementing a local exit detection system and may, in some versions of patient support apparatus 20, also implement a scale system. Still further, in some versions of the remote exit detection management system of the present disclosure, the force sensors 54 may be used as part of a remote exit detection system, although in other versions, the remote exit detection system may utilize other sensors, either in addition to, or in lieu of, force sensor 54 for remotely determining when a patient exits patient support apparatus 20, as will be described in greater detail below.

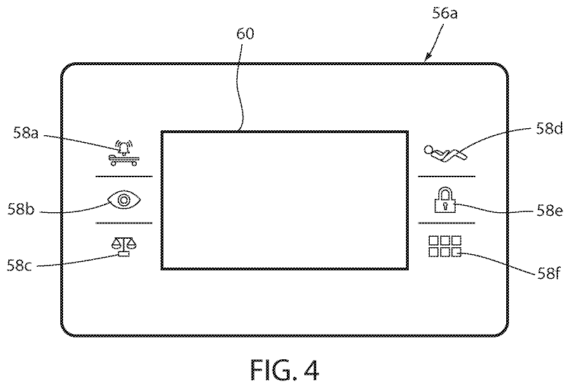

Patient support apparatus 20 further includes a plurality of control panels 56 (FIG. 1) that enable a user of patient support apparatus 20, such as a patient and/or an associated caregiver, to control one or more aspects of patient support apparatus 20. In the version shown in FIG. 1, patient support apparatus 20 includes a footboard control panel 56a, a pair of outer siderail control panels 56b (only one of which is visible), and a pair of inner siderail control panels 56c (only one of which is visible). Footboard control panel 56a and outer siderail control panels 56b are intended to be used by caregivers, or other authorized personnel, while inner siderail control panels 56c are intended to be used by the patient associated with patient support apparatus 20. Each of the control panels 56 includes a plurality of controls 58 (see, e.g. FIG. 4), although each control panel 56 does not necessarily include the same controls and/or functionality.

Among other functions, controls 58 of control panel 56a may allow a user to control one or more of the following: change a height of support deck 30, raise or lower head section 42, take patient weight readings, arm and disarm a local exit detection system, activate and deactivate a brake for wheels 24, arm and disarm one or more patient support apparatus monitoring functions, change various settings on patient support apparatus 20, view the current location of the patient support apparatus 20 as determined by a location detection system, perform a calibration process on the patient support apparatus 20, and perform still other actions. One or both of the inner siderail control panels 56c also include at least one control 58 that enables a patient to call a remotely located nurse (or other caregiver).

Control panel 56a includes a display 60 (FIG. 4) configured to display a plurality of different screens thereon. Display 60 may be a touchscreen that displays one or more controls and/or one or more control screens, some of which are discussed in greater detail below. Display 60 may comprise an LED display, OLED display, or another type of display.

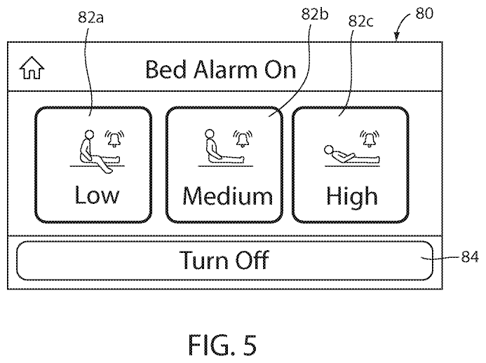

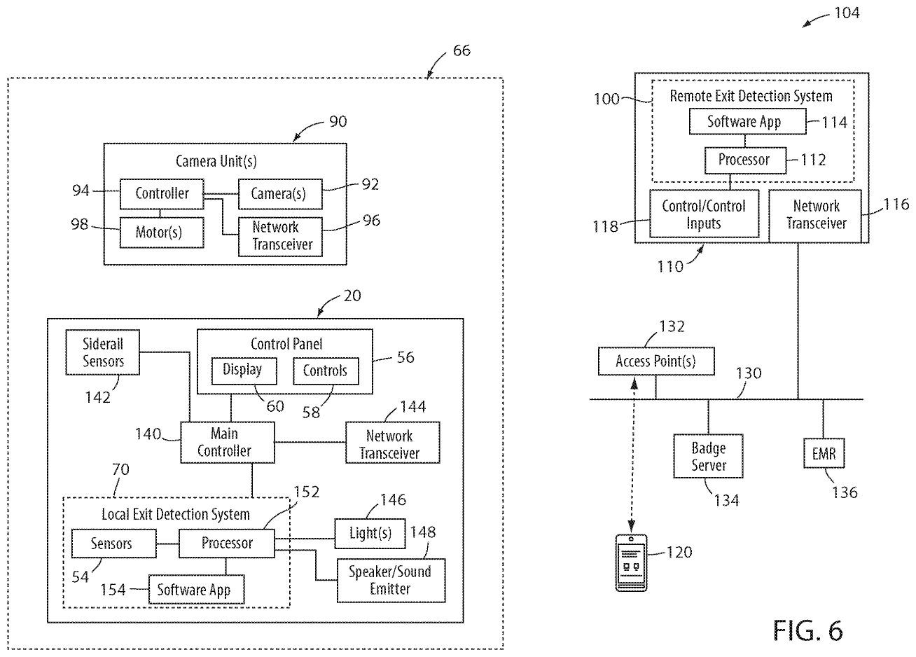

Surrounding display 60 are a plurality of navigation controls 58a-f that, when activated, cause the display 60 to display different screens on display 60. For example, when a user presses navigation control 58a, control panel 56a displays an exit detection control screen on display 60 that includes one or more icons that, when touched, control a local exit detection system 70 (FIG. 6). In some versions, the local exit detection control screen may look like, or include the functions illustrated in, the control screen shown in FIG. 5, although other screens and/or functionality may be illustrated thereon and/or incorporated thereinto.

The local exit detection system 70 is adapted to issue an alert when a patient exits from patient support apparatus 20. Local exit detection system 70 may include any of the same features and/or functions as, and/or may be constructed in any of the same manners as, the exit detection systems disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES, and/or the exit detection system disclosed in commonly assigned U.S. Pat. No. 5,276,432 issued to Travis and entitled PATIENT EXIT DETECTION MECHANISM FOR HOSPITAL BED, the complete disclosures of both of which are incorporated herein by reference.

When a user presses navigation control 58b (FIG. 4), control panel 56a displays a monitoring control screen that includes a plurality of control icons that, when touched, control an onboard monitoring system that may be built into patient support apparatus 20. The onboard monitoring system alerts the caregiver through a unified indicator, such as a light or a plurality of lights controlled in a unified manner, when any one or more of a plurality of settings on patient support apparatus 20 are in an undesired state, and uses that same unified indicator to indicate when all of the plurality of settings are in their respective desired states. Stated alternatively, the monitoring system, when armed, monitors the states of a plurality of components of patient support apparatus 20, rather than the state of the patient (such as is monitored by local exit detection system 70). The components of patient support apparatus 20 that may be monitored by the monitoring system include, but not limited to, any one or more of the following: the brake status, the siderail positions, the litter frame height, the exit detection system, the A/C cord status, the nurse call cable status, etc. When any one or more of these conditions are in an undesired state, the monitoring system issues an alert. Further details of one type of monitoring system that may be built into patient support apparatus 20 are disclosed in commonly assigned U.S. patent application Ser. No. 62/864,638 filed Jun. 21, 2019, by inventors Kurosh Nahavandi et al. and entitled PATIENT SUPPORT APPARATUS WITH CAREGIVER REMINDERS, as well as commonly assigned U.S. patent application Ser. No. 16/721,133 filed Dec. 19, 2019, by inventors Kurosh Nahavandi et al. and entitled PATIENT SUPPORT APPARATUSES WITH MOTION CUSTOMIZATION, the complete disclosures of both of which are incorporated herein by reference. Other types of monitoring systems may be included within patient support apparatus 20 and/or the monitoring system may be omitted.

When a user presses navigation control 58c, control panel 56a displays a scale control screen that includes a plurality of control icons that, when touched, control a scale system of patient support apparatus 20. When included, the scale system of patient support apparatus 20 may include any of the same features, components, and/or and functions as the scale systems disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES, and U.S. patent application Ser. No. 62/885,954 filed Aug. 13, 2019, by inventors Kurosh Nahavandi et al. and entitled PATIENT SUPPORT APPARATUS WITH EQUIPMENT WEIGHT LOG, the complete disclosures of both of which are incorporated herein by reference. The scale system may utilize the same force sensors that are utilized by the local exit detection system 70, in some versions, or it may utilize one or more different sensors.

When a user presses navigation control 58d, control panel 56 displays a motion control screen that includes a plurality of control icons that, when touched, control the movement of various components of patient support apparatus 20, such as, but not limited to, the height of litter frame 28 and the pivoting of head section 42. In some versions, the motion control screen displayed on display 60 in response to pressing control 58d may be the same as, or similar to, the position control screen 216 disclosed in commonly assigned U.S. patent application Ser. No. 62/885,953 filed Aug. 13, 2019, by inventors Kurosh Nahavandi et al. and entitled PATIENT SUPPORT APPARATUS WITH TOUCHSCREEN, the complete disclosure of which is incorporated herein by reference. Other types of motion control screens may be included on patient support apparatus 20.

When a user presses navigation control 58e (FIG. 4), control panel 56a displays a motion lock control screen that includes a plurality of control icons that, when touched, control one or more motion lockout functions of patient support apparatus 20. Such a motion lockout screen may include any of the features and functions as, and/or may be constructed in any of the same manners as, the motion lockout features, functions, and constructions disclosed in commonly assigned U.S. patent application Ser. No. 16/721,133 filed Dec. 19, 2019, by inventors Kurosh Nahavandi et al. and entitled PATIENT SUPPORT APPARATUSES WITH MOTION CUSTOMIZATION, the complete disclosure of which is incorporated herein by reference. Other types of motion lockouts may be included within patient support apparatus 20.

When a user presses on navigation control 58f, control panel 56a displays a menu screen that includes a plurality of menu icons that, when touched, bring up one or more additional screens for controlling and/or viewing one or more other aspects of patient support apparatus 20. Such other aspects include, but are not limited to, settings related to diagnostic and/or service information for patient support apparatus 20, mattress control and/or status information, configuration settings, location information, medical device association information, and other settings and/or information. One example of an illustrative menu screen is the menu screen 100 disclosed in commonly assigned U.S. patent application Ser. No. 62/885,953 filed Aug. 13, 2019, by inventors Kurosh Nahavandi et al. and entitled PATIENT SUPPORT APPARATUS WITH TOUCHSCREEN, the complete disclosure of which is incorporated herein by reference. Other types of menus and/or settings may be included within patient support apparatus 20.

For all of the navigation controls 58a-f (FIG. 4), screens other than the ones specifically mentioned above may be displayed on display 60 in other versions of patient support apparatus 20 in response to a user pressing these controls. Thus, it will be understood that the specific screens mentioned above are merely representative of the types of screens that are displayable on display 60 in response to a user pressing on one or more of navigation controls 58a-f. It will also be understood that, although navigation controls 58a-f have all been illustrated in the accompanying drawings as dedicated controls that are positioned adjacent display 60, any one or more of these controls 58a-f could alternatively be touchscreen controls that are displayed at one or more locations on display 60. Still further, although controls 58a-f have been shown herein as buttons, it will be understood that any of controls 58a-f could also, or alternatively, be switches, dials, or other types of non-button controls. Also, it will be understood that any of the functions associated with controls 58a-f may be omitted and/or modified from what has been described above.

As noted, FIG. 5 illustrates one example of a local exit detection system control screen 80 that may be displayed on display 60 of patient support apparatus 20 in some versions. Local control screen 80 allows a user to select one of three different sensitivity levels for local exit detection system 70, as well as to turn on (i.e. arm) and turn off (i.e. disarm) local exit detection system 70. More specifically, local control screen 80 includes low sensitivity icon 82a, a medium sensitivity icon 82b, and a high sensitivity icon 82c. In general, the different sensitivity levels refer to the breadth of movement that a patient can make without triggering a local exit detection alert. The low sensitivity level, which is selected by the user pressing on low sensitivity icon 82a, allows the patient to move the most without triggering an exit detection alert. The medium sensitivity level, which is selected by the user pressing on medium sensitivity icon 82b, allows the patient to move less than the low sensitivity level (but more than the high sensitivity level) before triggering an exit detection alert. And the highest sensitivity level, which is selected by the user pressing on high sensitivity icon 82c, is the most restrictive in terms of patient movement. That is, the patient is allowed to move the least amount before triggering an exit detection alert (when compared with the other sensitivity levels).

In some versions of patient support apparatus 20, local exit detection system 70 is configured to issue an exit alert when a patient's center of gravity moves outside of a particular zone. In those versions where the local exit detection system 70 is configured to allow the user to select different sensitivity levels, the different sensitivity levels may correspond to different zones. That is, if the user selects low sensitivity icon 82a (FIG. 5), the local exit detection system 70 repetitively compares the patient's center of gravity to a zone with a relatively large area. If the user selects high sensitivity icon 82c (FIG. 5), the local detection system 70 repetitively compares the patient's center of gravity to a zone with a relatively small area. If the user selects medium sensitivity icon 82b (FIG. 5), the local detection system 70 repetitively compares the patient's center of gravity to a zone having an area between the two other zones. Regardless of which zone is selected by the user, if the patient's center of gravity moves outside of the selected zone, the local exit detection system 70 issues an alert.

Local control screen 80 (FIG. 5) also includes an “turn off” control 84. The user presses on this control 84 whenever they wish to disarm local exit detection system 70. When disarmed, local exit detection system 70 does not issue an exit alert, nor does it compare the patient's center of gravity to a particular zone. In some versions of patient support apparatus 20, control 84 is a toggle control that alternates between turning off exit detection system 70 and turning on exit detection system 70. In such versions, after the user presses on the “turn off” control 84 shown in FIG. 5, exit detection system 70 will be disarmed and control 84 will change to a “turn on” control, thereby enabling the user to resume operation of local exit detection system 70.

Local exit detection system 70 is part of a remote bed exit management system 104 (FIG. 6) of the present disclosure, as will be explained in greater detail below. Remote bed exit management system 104 comprises a remote exit detection system 100 and, in some versions, a local exit detection system 70. The two exit detection systems 70 and 100 may be completely independent, partially interdependent, or completely dependent, depending upon how they are configured and/or depending upon the particular version of remote bed exit management system 104 that is implemented. It will be understood that local control screen 80 controls only the operation of local exit detection system 70, and does not influence the armed/disarmed state of remote exit detection system 100, and/or the sensitivity level (or other variables) of remote exit detection system 100.

Local exit detection system 70 may include any of the features and functions as, and/or may be constructed in any of the same manners as, the exit detection system disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES, the complete disclosure of which is incorporated herein by reference. In some versions, local exit detection system 70 includes a plurality of load cells adapted to detect the downward weight exerted by the patient when he or she is positioned on support deck 30. In such versions, exit detection system 70 may use the outputs of the load cells to monitor the center of gravity of the patient and issue an alert, when armed, if the patient's center of gravity travels outside of a selected zone or boundary, such as is explained in greater detail in U.S. Pat. No. 5,276,432 issued to Travis, the complete disclosure of which is incorporated herein by reference. Other types of exit detection systems may be included within patient support apparatus 20.

FIG. 6 illustrates in more detail the internal structures of several of the components of the remote bed exit management system 104 according to one aspect of the present disclosure. In the example shown in FIG. 6, remote bed exit management system 104 includes patient support apparatus 20, a camera unit 90, a remote server 110, and, in some versions, one or more mobile devices, such as one or more badges 120. It will be understood that these components are not necessarily a complete or necessary list of components of remote bed exit management system 104, nor are the individual sub-components of each of these components a complete or necessary list of components. It will therefore be understood that system 104 may include additional or fewer components than those depicted in FIG. 6, and that each individual component may also or alternatively include fewer or additional sub-components beyond what is shown therein.

Patient support apparatus 20 includes (FIG. 6) a main controller 140, a plurality of siderail sensors 142, a network transceiver 144, one or more lights 146, one or more speakers and/or other type of sound emitters 148, and local exit detection system 70. Each of these components are in communication with each other in one or more conventional manners, such as, but not limited to, one or more the following: a Controller Area Network (CAN); an I-Squared-C bus; a Local Interconnect Network (LIN) bus, Firewire; RS-232; RS-485; Universal Serial Bus (USB); Ethernet; a Serial Peripheral Interface (SPI) bus, and/or in other manners.

As shown in FIG. 6, local exit detection system 70 includes one or more sensors 54, a processor 152, and a local software application 154 that is executed by processor 152. In some versions of patient support apparatus 20, main controller 140 may execute software application 154, in which case processor 152 may be omitted. Patient support apparatus 20, camera unit 90, and local area network 130 may include additional components beyond those shown in FIG. 6. Alternatively, or additionally, one or more of the components shown in FIG. 6 may be omitted from remote bed exit management system 104, or replaced by other components.

Siderail sensors 142 of patient support apparatus 20 are adapted to detect whether siderails 36 are in their raised or lowered position and to report this information to main controller 140. Siderail sensors 142 may be conventional siderail sensors used with many types of patient support apparatuses 20, as would be known to one of ordinary skill in the art. As will be discussed in greater detail below, main controller 140 may be configured to forward the raised/lowered position of one or more siderails 36 to local exit detection system 70 and/or remote exit detection system 100. Exit detection systems 70 and/or 100 may utilize the raised/lowered position of one or more of siderails 36 when determining whether to issue an exit alert. In some versions, local and/or remote exit detection systems 70 and/or 100 may change the size and/or shape of a zone based on which siderails 36 are raised and which are lowered, and then compare the patient's center of gravity to that particular zone (and issue an alert if it is outside of that zone). In other versions, local and/or remote exit detection systems 70 and/or 100 may utilize the raised/lowered positions of siderails 36 to change the exit detection algorithm followed by software applications 154 and/or 114 in other manners.

Network transceiver 144 (FIG. 6) is adapted to communicate with the healthcare facility's local area network 130. In some versions, network transceiver 144 is a conventional WiFi transceiver (i.e. IEEE 802.11 . . . ) adapted to wirelessly communicate with one or more wireless access points 132 of the healthcare facility's local area network 130. In other versions, network transceiver 144 may be a wireless transceiver that uses conventional 5G technology to communicate with network 130, one or more servers hosted thereon, and/or other devices. In some versions, network transceiver 144 may include any of the structures and/or functionality of the communication modules 56 disclosed in commonly assigned U.S. Pat. No. 10,500,401 issued to Michael Hayes and entitled NETWORK COMMUNICATION FOR PATIENT SUPPORT APPARATUSES, the complete disclosure of which is incorporated herein by reference. Still other types of wireless network transceivers may be utilized.

In other versions, network transceiver 144 may be a conventional Ethernet transceiver electrically coupled to a conventional Ethernet port (i.e. RJ-45 jack, or the like) built into patient support apparatus 20 that allows a conventional Ethernet cable to be coupled to the patient support apparatus 20. In these versions, patient support apparatuses 20 may be coupled to the healthcare facility's network 130 by a wired connection. In still other versions, patient support apparatus 20 may have both wired and wireless transceivers 68. Still further, in some versions, transceiver 144 may take on yet a different form (e.g. a wireless ZigBee transceiver, a Bluetooth transceiver, etc.).

Patient support apparatus 20 uses transceiver 144 (FIG. 6) to communicate with remote server 110 and remote exit detection system 100. Remote server 110 and remote exit detection system 100 may be adapted to receive readings from sensors 54 of local exit detection system 70 and use those readings to determine remotely whether a patient has exited from patient support apparatus 20 or not. In other versions, remote exit detection system 100 may utilize readings from other sensors, including, but not limited to, other sensors that are not positioned on patient support apparatus 20, such as one or more cameras from camera unit 90, to determine remotely whether a patient has exited from patient support apparatus 20 or not. In some versions of patient support apparatus 20, main controller 140 is adapted to forward readings from sensors 54 to remote exit detection system 100 regardless of the armed or disarmed state of local exit detection system 70.

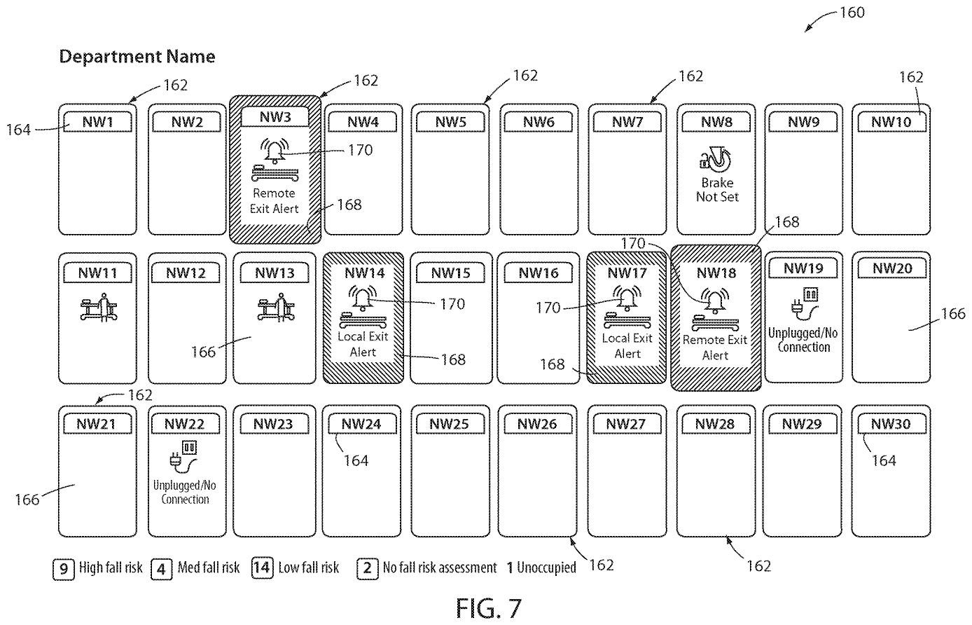

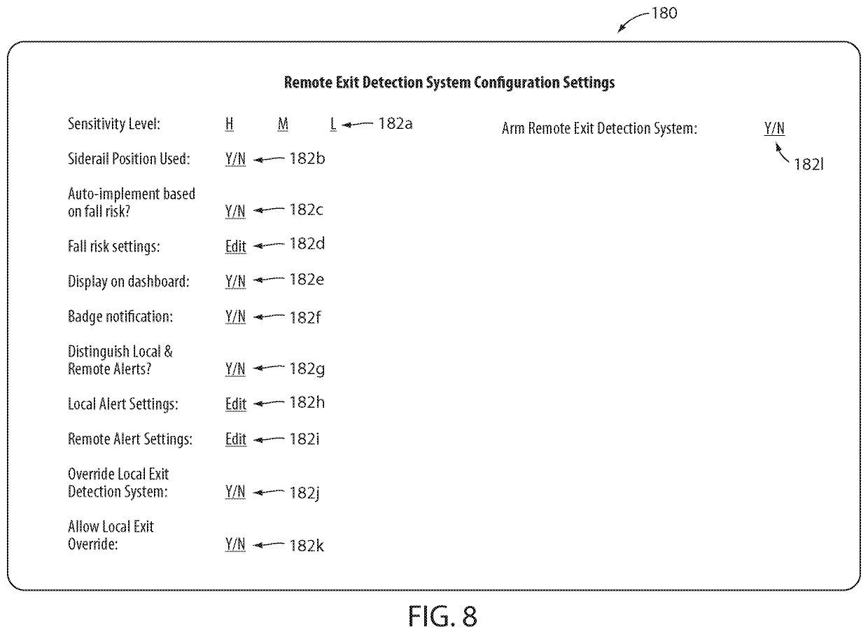

Remote server 110 may be configured to communicate information to one or more mobile electronic devices, such as one or more badges 120. Such information may include alerts from local exit detection system 70 and/or alerts from remote exit detection system 100. In addition to, or in lieu of, badges 120, remote server 110 may be configured to communicate with one or more smart phones, tablets, laptops, Computers on Wheels (CoWs), desktop computers, and the like. Such devices, including badges 120, may include a display on which various screens may be displayed, including, in some versions, a screen of the types shown in FIGS. 7-8. In some versions, remote exit detection system 100 allows authorized users to remotely configure and remotely control various aspects of the remote exit detection system 100 using a computer device in communication with network 130.

Patient support apparatus 20 may also include one or more lights 146 and/or one or more speakers and/or other sound-emitting devices 148. Such lights 146 and/or sound-emitting devices 148 are controlled by main controller 140 and are activated to signal a patient exit detection event has been detected by local exit detection system 70. In other words, when a patient exits patient support apparatus 20 while local exit detection system 70 is armed, main controller 140 and/or processor 152 are configured to activate lights 146 and/or sound-emitting device 148 in a manner that attracts a caregiver's attention and indicates that an exit alert is occurring.

Sensors 54, in some versions of patient support apparatus 20, may be load cells adapted to detect downward forces exerted by an occupant of support deck 30. Thus, when an occupant is positioned on support deck 30 and remains substantially still (i.e. not moving in a manner involving accelerations that cause forces to be exerted against support deck 30), sensors 54 will detect the weight of the occupant (as well as the weight of any components of patient support apparatus 20 that are supported—directly or indirectly—by force sensors 54). It will be understood by those skilled in the art, that sensors 54 may be implemented as other types of sensors, such as, but not limited to, linear variable displacement transducers and/or any one or more capacitive, inductive, and/or resistive transducers that are configured to produce a changing output in response to changes in the force exerted against them. Although patient support apparatus 20 may include a total of four force sensors 54, it will be understood by those skilled in the art that different numbers of sensors 54 may be used in accordance with the principles of the present disclosure.

Main controller 140 and processor 152 may be constructed of any electrical component, or group of electrical components, which are capable of carrying out the functions described herein. In many versions, controller 140 and/or processor 152 are conventional microcontrollers, although not all such versions need include a microcontroller. In general, controller 140 and/or processor 152 may include any one or more microprocessors, microcontrollers, field programmable gate arrays, systems on a chip, volatile or nonvolatile memory, discrete circuitry, and/or other hardware, software, or firmware that is capable of carrying out the functions described herein, as would be known to one of ordinary skill in the art. Such components can be physically configured in any suitable manner, such as by mounting them to one or more circuit boards, or arranging them in other manners, whether combined into a single unit or distributed across multiple units. Indeed, in some versions, main controller 140 and processor 152 are combined with each other and/or with other circuitry or other controllers that are present on patient support apparatus 20. The instructions followed by controller 140 and processor 152 in carrying out the functions described herein, as well as the data necessary for carrying out these functions, are stored in one or more memories that are accessible to them.

Remote server 110 includes one or more processors 112 that are adapted to execute a remote software application 114 that communicates with patient support apparatus 20 and/or one or more camera units 90. Processor 112 and software application 114 together form a remote exit detection system 100 that, as noted, may operate independently or partially in concert with local exit detection system 70. Remote server 110 includes one or more network transceivers 116 that communicatively couple remote server 110 to a local area network 130 of the healthcare facility in which system 104 is implemented.

Remote server 110 may also include one or more controls or control inputs 118 that enable a user of remote exit detection system 100 to control and/or configure remote exit detection system 100. Such controls may be physically coupled to remote server, such as via a keyboard, mouse, and/or other computer technology. Alternatively, or additionally, a desktop computer, laptop, tablet, smart phone, or other computing device may be in communication with remote server 110 via network 130 and the keyboard, touchscreens, computer mouses, and/or the other controls of those devices may server as a control input 118 to remote server 110, thereby enabling authorized individuals with access to network 130 and remote server 110 to control the operation of remote exit detection system 100.

Local area network 130 is in communication with a plurality of conventional wireless and/or wired access points 132, a badge server 134, an electronic medical records server 136, and, in some healthcare facilities, one or more additional servers (not shown), including one or more servers that are coupled to local area network 130 by way of the Internet. Indeed, in some versions of remote bed exit management system 104, remote exit detection system 100 may be partially and/or completely hosted on a server that is remote from local area network 130, but that is in communication therewith via the Internet. In other versions, remote server 110 may be housed locally on the premises of the healthcare facility in it is installed.

Camera unit 90 (FIG. 6) includes one or more cameras 92, a controller 94, a network transceiver 96, and one or more motors 98. Camera units 90 are positioned at fixed locations within the healthcare facility. Typically, a camera unit 90 is positioned inside of a patient room 66 in a location where camera 92 will have a field of view that captures a patient support apparatus 20. In other words, each camera unit 90 is typically positioned such that its camera(s) 92 will be pointed toward a bed bay of a room or area of the healthcare facility. In some healthcare facility, camera units 90 may be placed elsewhere, such as in hallways, or other areas. Each camera unit 90 may include a unique identifier that is communicated to remote server 110. The location of each camera unit 90 is surveyed after installation and stored in a memory, along with its unique identifier, which is accessible to remote server 110. In this manner, server 110 is able to correlate messages from camera units 90 to specific locations within the healthcare facility. For example, if a first camera unit 90 is installed in room 402 and bears the unique identifier XYZ, that camera unit 90 will include the unique identifier XYZ in its communications so that server 110 will know which specific camera unit 90 is it communicating with. Further, from the results of the surveying operation, server 110 will be able to determine the location of that particular camera unit 90 within the healthcare facility.

Camera units 90 may be camera units of the type formerly marketed by careai.com of Orlando, Florida, and now marketed by Stryker Corporation of Kalamazoo and integrated into Stryker's SmartCare Platform. Such camera units include, but are not limited to, the Smart Patient Room AMS-RS-PRO, the Virtual Care AMS-0RS Ultra, the AMS-M2-PRO, the Smart Spaces AMS-M2 Ultra, the AMS-T2, and still other types of camera units 90. Camera units 90 may, of course, take on other forms and/or be manufactured by other entities.

Motor(s) 98 of camera units 90 are controlled by controller 94 and used to aim and/or focus camera 92 in a manner such that the field of view of camera 92 captures patient support apparatus 20. Camera unit controller 94 may take on a variety of different forms, such as one or more conventional microcontrollers. However, as with main controller 140 and processor 152, controller 94 may be modified to use a variety of other types of circuits—either alone or in combination with one or more microcontrollers—such as, but not limited to, any one or more microprocessors, field programmable gate arrays, systems on a chip, volatile or nonvolatile memory, discrete circuitry, and/or other hardware, software, or firmware that is capable of carrying out the functions described herein, as would be known to one of ordinary skill in the art. Such components can be physically configured in any suitable manner, such as by mounting them to one or more circuit boards, or arranging them in other manners, whether combined into a single unit or distributed across multiple units. The instructions followed by controller 94 when carrying out the functions described herein, as well as the data necessary for carrying out these functions, are stored in one or more accessible memories.

Network transceiver 96 (FIG. 6) of camera unit 90 is adapted to communicate with local area network 130 and remote server 110 via one or more access points 132. Network transceiver 96 may be the same type of transceiver as network transceivers 116 and 144. That is, in some versions, network transceiver 96 may be a WiFi radio and/or a wired Ethernet transceiver, or still another type of transceiver.

Controller 94 has access to a database (not shown) that contains data that is used by controller 94 in analyzing the images captured by camera 92 and, in some versions, determining from those images whether a patient onboard patient support apparatus 20 is exiting the patient support apparatus 20 or not. Such data may include, but is not necessarily limited to, any of the following: visual attribute data, such as color, size, shape, and/or other data, that assist controller 94 in identifying patient support apparatus 20, including any visual indicator 32 that is part of patient support apparatus 20. Such visual attribute data may assist controller 94 in identifying the siderails 36 of the patient support apparatus 20, the head or Fowler section 42 of the patient support apparatus 20, the mattress, the headboard, the footboard 34, the control panels 56 on the patient support apparatus 20, and/or other components of the patient support apparatus 20 that may be positioned within the field of view of one or more of the cameras 92.

In some embodiments, camera unit controller 94 may include commercially available software that is adapted to carry out the image analysis discussed herein. For example, in some embodiments, camera unit controller 94 may utilize the commercially available software suite referred to as OpenCV (Open Source Computer Vision Library), which is an open source computer vision library supported by Willow Garage of Menlo Park, California. The OpenCV library has been released under the Berkeley Software Distribution (BSD) open source license. The OpenCV library has more than 2500 computer vision algorithms and is available for use with various commercially available operating systems, including Microsoft Windows, Linux/Mac, and iOS. The OpenCV algorithms include a comprehensive set of both classic and state-of-the-art computer vision and machine learning algorithms. These algorithms are designed to be used to detect and recognize faces, identify objects, classify human actions in videos, track camera movements, track moving objects, extract 3D models of objects, produce 3D point clouds from stereo cameras, stitch images together to produce high resolution images of entire scenes, find similar images from an image database, follow eye movements, recognize scenery and establish markers to overlay scenery with augmented reality, and other tasks.

The OpenCV library has included multiple major releases, and any one of these major versions (as well as any of the multiple intermediate versions), is suitable for carrying out the features and functions described in more detail herein. In at least one version of camera unit 90, customized software is added to interact with and utilize various of the software algorithms of the OpenCV library in order to carry out the features described herein. Other commercially available software may also be used, either in addition to or in lieu of the OpenCV library. Alternatively, or additionally, any of the image analysis functions carried out by camera unit controller 94 may alternatively be carried out, either wholly or in part, by remote server 110 and/or other computers that are in communication with camera unit 90.

In some versions, each camera 92 may have its own image processor integrated therein that is adapted to partially or wholly process the images captured by the image sensor of the camera 92. For example, when using an Intel D400 series camera as camera 92, these cameras include an Intel RealSense Vision Processor D4, along with other electronic circuitry, which performs various vision processing on the signals captured by the various sensors that are part of the D400 series of cameras. For purposes of the following description, the use of the term “outputs,” “signals,” “image signals,” or the like from cameras 92 will refer to either unprocessed image data captured by the camera 92, or partially or wholly processed image data that is captured by camera 92 and partially or wholly processed by the processor integrated into the camera 92.

As noted, camera units 90 are adapted, in at least one version, to capture images of patient support apparatus 20 and a patient positioned thereon, analyze the images, and determine from the analyzed images whether the patient positioned thereon is exiting, or attempting to exit. The outputs from the camera 92 is forwarded, whether completely processed, partially processed, or unprocessed, to remote server 110. IF the outputs need further processing, processor 112 and software app 114 are configured to complete the processing of the images captured by camera unit 90 to determine if a patient is exiting or not, in accordance with the settings of remote exit detection system 100.

In an alternative version of remote bed exit management system 104, camera units 90 may be omitted and remote exit detection system 100 may utilize outputs from other sensors to remotely determine whether a patient is exiting patient support apparatus 20 or not. In some such versions, the outputs from force sensors 54 are forwarded to remote server 110 and remote exit detection system 100 utilizes those outputs to determine if a patient is exiting or not. As was noted previously, in such versions, main controller 140 of patient support apparatus 20 may be configured to forward the outputs of force sensors 54 to remote exit detection system 100 regardless of whether local exit detection system 70 is armed or disarmed. In such versions, although remote exit detection system 100 relies on the outputs from the local force sensors 54, the operation of remote exit detection system 100 can take place completely independently of the operation of local exit detection system 70. In other words, remote exit detection system 100 can be armed, disarmed, and/or configured independently of the armed, disarmed, and/or configuration state of local exit detection system 70.

In those situations where the outputs of force sensors 54 are forwarded to remote exit detection system 100, processor 112 may be adapted by software app 114 to process those outputs to determine a center of gravity of the patient and to check to see if the center of gravity has moved outside of a predetermined area or zone. In some versions of software app 114, the user of remote exit detection system 100 may select the zone used by remote exit detection system 100, thereby enabling the user to select a sensitivity level of the remote exit detection system 100. The particular zones that the user may select may be different from the particular zones that a user may select using a control panel 56 of the patient support apparatus 20 (see, e.g. FIG. 5). In other words, remote exit detection system 100 does not need to utilize the same sensitivity levels as local exit detection system 70, even in those situations where both local exit detection system 70 and remote exit detection system 100 are using the same force sensors 54. Of course, in some versions of remote exit detection system 100, processor 112 may utilize the same zones as processor 152 utilizes when determining whether a patient has exited or not. However, in other versions, processor 112 of remote server 110 may include additional zones, and/or not use any of the same zones, as are used by processor 152 of patient support apparatus 20.

As was noted previously, local area network 130 may include a conventional badge server 134, EMR server 136, and/or other servers. Badge server 134 (FIG. 6) is configured to manage communications between, and keep track of the locations of, the specific caregivers assigned to individual badges 120. The badges 120 are typically worn by healthcare workers, such as caregivers, service technicians, cleaning personnel, transportation assistants, etc. Badge server 134 maintains a set of data that correlates badge IDs with individual healthcare workers. Each badge 120 includes a unique ID that distinguishes that badge from other badges. When a healthcare provider arrives at a healthcare facility, he or she typically grabs a badge from a common collection of badges and wears it for the duration of his or her work shift (and returns it to the general collection after his/her shift). For some badge servers 134, in order for the badge server 134 to know that a particular badge is assigned to a particular healthcare worker, the worker manually associates the particular badge they choose to wear that day with their name (or some other worker ID). This manual association may involve scanning the badge on a badge reader in communication with server 134, typing information (such as the badge ID and/or the worker's ID) into a computer coupled to server 134, entering information into the badge (if it is a badge that allows data entry), performing other actions, and/or a combination of these steps.

Regardless of how implemented, remote exit detection system 100 is configured to communicate with badge server 134 when a remote or local exit alert is issued. In this manner, when remote exit detection system 100 and/or local exit detection system 70 detects a patient exiting from patient support apparatus 20, remote exit detection system 100 is able to forward an alert to badge server 134 instructing badge server 134 which caregivers are to be notified of the exit alert on their respective badges 120. Caregivers carrying badges 120 can therefore be apprised via their respective badges 120 when a patient under their care exits from a patient support apparatus 20 (while local and/or remote exit detection systems 70 and/or 100 are armed).

EMR server 136 (FIG. 6) stores individual patient records. Such patient records identify a patient by name and the medical information associated with that patient. Such medical information may include all of the medical information generated from the patient's current stay in the healthcare facility as well as medical information from previous visits. It will be understood that the term “EMR server,” as used herein, also includes Electronic Health Records servers, or EHR servers for short, and that the present disclosure does not distinguish between electronic medical records and electronic health records. In some conventional EMR servers 136, a patient's fall risk is stored therein after being determined by a healthcare professional. In such versions of EMR server 136, remote exit detection system 100 may be configured to communicate with EMR server 136 to determine the fall risk classification of a particular patient. Remote exit detection system 100 may then utilize, in some versions, this fall risk information in different manners, depending upon how remote exit detection system 100 has been configured by authorized users in the healthcare facility.

For example, in some versions, remote exit detection system 100 may be configured to automatically arm remote exit detection system 100 when a particular patient has a high or medium fall risk, and to not automatically arm remote exit detection system 100 when the patient has a low fall risk. Alternatively, or additionally, remote exit detection system 100 may automatically determine a sensitivity level of remote exit detection system based on the patient's fall risk and/or based on other information, including information obtained from EMR server 136. In some versions, remote exit detection system 100 may be configured to also forward some or all of the information it receives from EMR server 136 to local exit detection system 70, and local exit detection system 70 may use this information in carrying out its local patient exit detection. When so configured, local exit detection system 70 may utilize the information from EMR server 136 in a manner that is independent of how remote exit detection system 100 utilizes that information (i.e. it may utilize the information in a completely different manner, in a partially different manner, or in a manner that is completely the same).

Other servers (not shown) may also be communicatively coupled to network 130, as noted previously. Once such additional server may be a conventional caregiver assignment server that matches specific caregivers to specific rooms, bays, and/or patients within the healthcare facility. Alternatively, or additionally, such information may be stored in other servers hosted on, or in communication with, network 130. Regardless of where located, remote exit detection system 100 may be configured to automatically retrieve this information so that, when it detects a patient exit, it can instruct which specific caregivers are to be notified and to then send that information to badge server 134 and/or to other recipients. Badge server 134 then forwards an alert message to the badge(s) 120 of the appropriate caregiver(s).

In some versions, remote software app 114 is adapted to receive exit alerts from local exit detection system 70, as well as to process alerts from remote exit detection system 100. That is, in addition to hosting remote exit detection system 100, remote software app 114 may receive notifications from patient support apparatus 20 when its exit detection system 70 detects a patient exiting therefrom. Remote software app 114 is further adapted to allow a user to customize how remote software app 114 will react to both local exit alerts from local exit detection system 70 and remote exit alerts from remote exit detection system 100. Such customization for the remote exit alerts may be different from the customization for the local exit alerts. Thus, for example, remote software app 114 may notify a first caregiver in a first manner when local exit detection system 70 detects a patient exit, and notify a second caregiver in a second manner when remote exit detection system 100 detects a patient exit. The first and second caregivers may be different and/or the first and second manners may be different.

It will also be understood that local and remote exit detection systems 70 and 100 need not be simultaneously armed or disarmed. One of these can be disarmed while the other is armed, or vice versa. As was noted previously, software app 114 may be configured to automatically retrieve a fall risk score for a patient from EMR server 136, and/or retrieve other data about a patient assigned to patient support apparatus 20 and, based on the retrieved data, automatically arm remote exit detection system 100 with an automatically chosen sensitivity level and automatically chosen alerting rules (e.g. who to alert, in what manner, when to escalate, etc.). This automatic implementation of the remote exit detection system 100 ensures that, if a caregiver fails to arm local exit detection system 70 using a control panel 56 of patient support apparatus 20, the patient's exit will still be detected by remote exit detection system 100.

In some versions of remote exit detection system 100, software app 114 is configured to automatically arm remote exit detection system 100 in response to detecting a patient's presence on patient support apparatus 20. Such detecting of the patient's presence, in some versions, is carried out by force sensors 54 which, when they detect a weight above a threshold, notify main controller 140, which in turn forwards that information to remote exit detection system 100 via network transceiver 144. Alternatively, or additionally, remote exit detection system 100 may detect the patient's presence in patient support apparatus 20 via camera unit 90. When camera 92 captures images of the patient on patient support apparatus 20, camera unit 90 informs remote exit detection system 100 via network transceiver 96. Remote exit detection system 100 then automatically arms itself (assuming the patient is a fall risk and/or assuming that remote exit detection system 100 has been configured for such automatic arming).

In some versions, remote exit detection system 100 may base its decision to automatic self-arm upon information received from an Admission, Discharge, and Transfer (ADT) server (not shown) that is in communication with network 130. The ADT server keeps track of when patients are admitted to, discharged from, or transferred within, the healthcare facility. If no patient is assigned to a particular patient support apparatus 20, as indicated by the ADT system, remote exit detection system 100 may be configured to ignore (i.e. not self-arm) when it detects a person on patient support apparatus 20 (either through camera unit 90 and/or force sensors 54). In such cases, the person detected may be a cleaner or other individual who is not the patient assigned to patient support apparatus 20, in which case remote exit detection system 100 should not be, and is not, automatically armed.

Remote exit detection system 100, in some versions, is configured to repetitively communicate with EMR server 136 so that any changes to a patient's fall risk classification, or other relevant health factors, are detected by remote exit detection system 100, thereby allowing remote exit detection system 100 to make automatic adjustments to its arming state and other configurations (e.g. its sensitivity level, its manner of issuing remote exit alerts, etc.). In this manner, for example, if a patient who is not a high fall risk when they initially enter the healthcare facility, but later becomes a high fall risk (due to, for example, having recently underwent surgery), can have remote exit detection system 100 automatically disarmed while they are a low fall risk, and then automatically armed when they become a high fall risk.

FIG. 7 illustrates a dashboard screen 160 that may be generated by remote software app 114 and displayed on any computer or computing device that is communicatively coupled to remote server 110 via network 130. Thus, for example, dashboard screen 160 may be displayed on a large screen computer monitor or television that has an Internet connectivity. Alternatively, or additionally, dashboard screen 160 may be displayed on one or more computer screens at one or more nurses'stations within the healthcare facility. Dashboard screen 160 may be displayed at still other locations.

Dashboard screen 160 (FIG. 7) includes a plurality of room icons 162 (i.e. enclosures that are defined by rectangles having rounded corners). Each room icon 162 corresponds to a particular room and/or bay within an actual room of the healthcare facility in which remote bed exit management system 104 is installed. Thus, in the example shown in FIG. 7, there are thirty room icons 162. Each room icon 162 includes a header portion 164 that identifies the particular room in the healthcare facility to which the room icon 162 corresponds and a body portion 166 that, as will be discussed more below, may display information about the status of the patient and/or the patient support apparatus 20 positioned within that particular room. Thus, in some versions of remote exit detection system 100, software app 114 is adapted to not only display alarms when a patient exits from patient support apparatus, but to also receive status data about the patient and/or patient support apparatus 20 and to display that status data on dashboard screen 160 in addition to exit alerts.

In the example shown in FIG. 7, dashboard screen 160 includes both a message and an icon in rooms NW14 and NW17 indicating that local exit detection system 70 has detected that the patients in those rooms have exited from their respective patient support apparatuses 20. In other words, a local exit alert has been issued for both of these rooms. In the example shown in FIG. 7, dashboard screen 160 displays the text “local exit alert” in the room icons 162 corresponding to rooms NW14 and NW17. It also displays an icon 170 indicating an exit alert has been issued for both of these rooms.

In the example shown in FIG. 7, dashboard screen 160 also includes both a message and an exit alert icon 170 in the room icons 162 corresponds to rooms NW3 and NW18 of the healthcare facility. The message includes the words “remote exit alert,” which indicate that remote exit detection system 100 has detected that the patients in these rooms have exited from their respective patient support apparatuses 20. In other words, a remote exit alert has been issued for both of these rooms. Although the exit alert icon 170 is the same for both remote and local exit alerts, it will be understood that software app 114 can be modified to allow a user to display different exit alert icons 170 for remote exit alerts versus local exit alerts.

In the example shown in FIG. 7, software app 114 has been configured by a user to display the local exit alerts (i.e. the exit alerts issued by local exit detection system 70) and the remote exit alerts (i.e. the exit alerts issued by remote exit detection system 100) in different manners. Specifically, software app 114 has been configured to enlarge a border of the room icons 162 corresponding to the rooms in which a remote exit alert has been detected. Thus, it can be seen in FIG. 7 that room icons 162 corresponding to rooms NW3 and NW18 have had their borders enlarged relative to the other room icons (including the room icons 162 corresponding to rooms NW14 and NW 17, which have a local exit alert displayed). It can also be seen that software app 114 has been configured to display highlighting 168 around the border of room icons 162 when an exit alert has been issued (whether local or remote).

Software app 114 may be configured to allow the user to customize how the remote exit alerts and local exit alerts are displayed on dashboard screen 160. In some versions, software app 114 may allow the user to select a first color for the highlighting 168 that appears around the border of the room icons 162 when a local exit alert happens, and to select a second and different color for the highlighting 168 that appears around the border of the room icons 162 when a remote exit alert happens. Alternatively, or additionally, software app 114 may allow the user to select different background colors for room icons 162 when a local exit alert versus a remote exit alert happens. As another option, software app 114 may be adapted to allow a user to enlarge the room icons 162 for both remote exit alerts and local exit alerts, for only one of these two types of alerts, or for neither of these types of alerts. As yet another option, software app 114 may be adapted to allow a user to select different exit alert icons 170 to be displayed on dashboard screen 160 for local exit alerts versus remote exit alerts. Software app 114 may allow still other customizations of the manner in which remote exit alerts and local exit alerts are displayed on dashboard screen 160, including manners in which the two types of exit alerts have one or more display aspects in common and manners in which the two types of exit alerts have one or more display aspects that are different from each other. In sum, software app 114 may be configured to allow a user to display remote and local exit alerts completely differently, completely the same, or partially the same and partially differently.

The configurations options provided to the user of software app 114 for issuing remote exit alerts may also allow the user to select colors for displaying on dashboard screen 160 and/or elsewhere; to select a sound or sounds to be emitted from one or more speakers in communication with remote server 110; to select a volume for the sound or sounds; to select whether one or more lights, icons, and/or screen images flash, or are otherwise modified; and/or to select still other configuration settings.

As was noted, software app 114 may be configured to also receive status data from patient support apparatuses 20 via network transceivers 144 and 116 and to display some or all of that status data on dashboard screen 160. Such status date may include, but is not limited to, a state of a brake on patient support apparatus 20, a state of the siderails 36 of patient support apparatus 20, a state of remote exit detection system 100 (e.g. armed/disarmed, sensitivity level, etc.), a state of local exit detection system 70 (e.g. armed/disarmed, sensitivity level, etc.), a height of litter frame 28, a state of a power cord and/or nurse call cable (e.g. plugged-in or unplugged), and/or still other states. In some versions of software app 114, software app 114 may be modified to monitor and/or display on dashboard screen 160 any one or more of the states that are monitored and displayed on the dashboard screen 162 of commonly assigned PCT patent application serial number PCT/US 2024/014966 filed Feb. 8, 2024, by applicant Stryker Corporation and entitled PATIENT SUPPORT APPARATUS SYSTEM, the complete disclosure of which is incorporated herein by reference.

FIG. 8 illustrates a configuration screen 180 that may be displayed by any computer device in communication software app 114 of remote exit detection system 100. That is, as with dashboard screen 160 of FIG. 7, software app 114 may display screen 180 on any display of any computing device that is communicatively coupled to remote server 110 via network 130. In some versions, software app 114 is configured to display screen 180 only to people who supply proper credentials via their computing device, such as a nurse manager or other healthcare professional who oversees the operation of the healthcare facility. In other words, software app 114 may be configured to allow different levels of access and configuration screen 180 may require a higher level of access than, for example, dashboard screen 160.

Configuration screen 180 (FIG. 8) allows an authorized user to configure how remote exit detection system 100 operates, including how it interacts with, or does not interact with, local exit detection 70. Configuration screen 180 includes a plurality of user-selectable controls 182a-l. It will be understood that the specific set of controls 182 shown in FIG. 8 is merely an illustrative set of controls that can be presented to the user by software app 114 and that, in different versions, software app 114 may present a greater number of controls 182, a less number of controls 182, and/or one or more different controls 182 from what is shown in FIG. 8.

Control 182a (FIG. 8) allows a user to set the sensitivity level (High (H), Medium (M), or Low (L)) for remote exit detection system 100. Selecting one of these sensitivity levels via control 182a does not affect the sensitivity level that a caregiver may select for local exit detection system 70 using local control screen 80 (FIG. 5). Thus, in some instances, a user may configure remote exit detection system 100 to have a different sensitivity level than that used by local exit detection system 70. If both are armed in such a situation, then one of the two exit detection systems 70, 100 will issue an alert sooner than the other. In addition, some versions of local exit detection system 70 may only include a single sensitivity level, or they may include a different number of sensitivity levels than the three depicted in FIG. 5. Similarly, some versions of remote exit detection system 100 may include only a single sensitivity level, or they may include a different number of sensitivity levels than the three depicted in FIG. 8.

Control 182b (FIG. 8) allows a user to determine whether the position of one or more of the siderails 36 will be taken into account by remote exit detection system 100 when determining whether to issue a patient exit alert. If taken into account, remote exit detection system 100 may require a higher threshold of patient movement toward a siderail 36 that is in the raised position before issuing an exit alert, and may issue an exit alert on the basis of a lower threshold of patient movement in the direction of a siderail 36 that is in a lowered position. In some versions, remote exit detection system 100 may be configured to not issue an exit alert when the patient's movement is toward a raised siderail unless and/or until the patient is trying to crawl over the raised siderail. As was noted previously, in some versions of remote exit detection system 100 that analyze the outputs of force sensors 54, remote exit detection system 100 may be configured to change the size, shape, and/or position of a zone based on the raised/lowered position of each of the siderails 36. The zone, as also noted previously, may be used to compare the patient's center of gravity to. In other versions of remote exit detection system 100, such as those that utilize camera units 90 instead of, or in addition to, force sensors 54, selecting control 182b may cause the remote exit detection system 100 to analyze the images captured by camera(s) 92 in different manners, depending upon whether the siderail 36 closest to the patient is raised or lowered (or the siderail 36 the patient is moving toward). If the user selects the “No” option of control 182b, then remote exit detection system 100 does not take into account the raised/lowered position of any of siderails 36 when determining whether to issue a remote exit alert.

Control 182c (FIG. 8) allows a user to select whether remote exit detection system 100 will automatically arm itself or not based upon a patient's fall risk. When the “Yes” option of control 182c is selected by the user, remote exit detection system 100 consults EMR server 136 to see what fall risk level the patient of patient support apparatus 20 is assigned. Based on the fall risk recorded in the EMR server 136, remote exit detection system 100 is configured to decide whether to automatically arm itself. If the user selects the “No” option of control 182c, remote exit detection system 100 does not automatically arm itself based upon a patient's fall risk status (although it may automatically arm itself based on other user-specified criteria).

If control 182c has its “Yes” option selected, control 182d then allows the user to specify the settings of remote exit detection system 100 that are to be used based upon the patient's fall risk. In some versions, when a user selects the “Edit” option for control 182d, remote exit detection system 100 displays an additional menu or configuration screen that allows the user to specify what conditions will cause remote exit detection system 100 to automatically arm itself and what conditions will not cause remote exit detection system 100 to automatically. For example, the user may be able to specify that high fall risk patients are to be automatically monitored by remote exit detection system 100 with a certain sensitivity level, medium fall risk patients are to be automatically monitored by remote exit detection system 100 with a different sensitivity level, low fall risk patients are not to be automatically monitored by remote exit detection systems 100, and patients who don't have a fall risk assigned in the EMR server 136 are to be automatically monitored with a specific sensitivity level. After these conditions are input into remote exit detection system 100 using the “edit” option of control 182d, remote exit detection system 100 automatically arms itself when it detects the conditions specified by the user and operates with the sensitivity level specified by the user.

Control 182e (FIG. 8) allows a user to select whether remote exit detection system 100 will display remote exit alert alarms on dashboard screen 160. If the “Yes” option is selected, when remote exit detection system 100 detects a patient exiting from patient support apparatus 20 (while system 100 is armed), it displays an exit alert on dashboard 160. If the “No” option is selected, remote exit detection system 100 does not display a detected remote exit alert on dashboard 160.

Control 182f (FIG. 8) allows a user to select whether a notification will be sent to one or more badges 120 when remote exit detection system 100 detects a patient exit. If the user selects the “Yes” option for control 182f, software app 114 may be configured to display an additional menu screen or window allowing the user to configure which badges are to be notified, what priority the notifications are assigned, how frequently reminders are sent, who is notified, how many caregivers are notified, and other parameters regarding the badge notification of a patient exit. In some versions of remote exit detection system 100, software app 114 may allow other types of notifications in addition to, or in lieu of, badge notifications, such as, but not limited to, cell phone notifications, computer workstation notifications, nurses'station notifications, etc. In such cases, these additional notification options may be displayed on configuration screen 180 or another screen of remote exit detection system 100.

Control 182g (FIG. 8) allows a user to select whether remote exit detection system 100 will distinguish between remote exit alerts and local exit alerts. If the user selects the “No” option, and remote exit detection system 100 is further configured to receive local exit alerts from local exit detection system 70, then remote exit detection system 100 notifies caregivers in the same manner, regardless of whether the local exit detection system 70 detects a patient or remote exit detection system 100 detects a patient exit. This means, for example, that remote exit detection system 100 will display remote and local exit alerts on dashboard screen 160 in the same manner so that a caregiver who views dashboard 160 will not be able to determine whether the exit alert issued from local exit detection system 70 or from remote exit detection system 100. Further, when the “No” option of control 182g is selected, remote exit detection system 100 sends the same notifications to badges 120, cell phones, nurses stations, and/or other computers, regardless of whether the patient exit was detected by remote exit detection system 100 or local exit detection system 70.

If the user selects the “Yes” option for control 182g, then software app 114 allows the user to input additional configuration information (such as through an additional pop-up window, or in other manners) that define how remote exit detection system 100 differentiated remote exit alerts from local exit alerts. Such differentiation may include displaying local and remote exit alerts in different manners on dashboard screen 160, sending notifications to different personnel, sending different types of notifications, changing other characteristics of the notifications (e.g. reminder frequency, escalation algorithms, sounds that are emitted, priority settings, etc.).

Control 182h (FIG. 8) allows a user to select how remote exit detection system 100 will react to an exit alert issued by local exit detection system 70. In some versions of software app 114, this control enables the user to make any of the following selections: ignore local exit alerts completely; display local exit alerts on dashboard 160 but not send any notifications to other devices (e.g. badges 120); send notifications to other devices but not display the local alerts on dashboard 160; send specific types of notifications (text messages, emails, etc.) in response to a local exit alert; send notifications to specific people in response to a local exit alert, etc. To make any of these and/or other selections, the user selects the “edit” option for control 182h, which brings up a separate screen and/or window that allows the user to make these selections.

It will be understood that control 182h does not affect how local exit detection system 70 processes its local exit alert. Therefore, for example, regardless of how control 182h is configured, a patient exit detected by local exit detection system 70 caused the patient support apparatus 20 to issue a sound via speaker/sound emitter 148 and/or to control one or more lights 146, depending upon how the user has configured the local exit detection system 70 using one of the control panels 56 of patient support apparatus 20. Additionally, if patient support apparatus 20 is configured to send a notification via network transceiver 144 to a different server (other than server 110) or different software application, that other server or software application may process the local exit alerts in whatever manner it is configured to do so, including, in some cases, displaying those local exit alerts on a different dashboard and/or sending notifications to caregivers independently of software app 114. Still further, local exit detection system 70 may be configured to communicate local exit alerts to a nurse call system via a conventional nurse call outlet that the patient support apparatus 20 is communicatively coupled to (such as via a cable or wirelessly). Such outlets often include 37 pins and a communication channel for communicating exit alerts on a specific one (or ones) of those pins. In sum, control 182h only affects how remote exit detection system 100 processes the local exit alerts, not how local exit detection system 70 processes its own local exit alerts.

Control 182i (FIG. 8) allows a user to select how remote exit detection system 100 reacts to remote exit alerts that it detects. In some versions of software app 114, this control enables the user to make any of the following selections: ignore remote exit alerts completely; display remote exit alerts on dashboard 160 but not send any notifications to other devices (e.g. badges 120); send notifications to other devices but not display the remote alerts on dashboard 160; send specific types of notifications (text messages, emails, etc.) in response to a remote exit alert; send notifications to specific people in response to a remote exit alert, etc. To make any of these and/or other selections, the user selects the “edit” option for control 182i, which brings up a separate screen and/or window that allows the user to make these selections. These selections do not affect how remote exit detection system 100 responds to any local exit alerts from local exit detection system 70 (as noted above, those responses are controlled by control 182h).

Control 182j (FIG. 8) allows a user to select whether the settings and/or configuration of local remote exit detection system 100 will override the same settings and/or configuration of local exit detection system 70. Thus, in those situations where both local and remote exit detection systems 70 and 100 are armed, control 182j allows the user to specify that remote exit detection system 100 will process both local and remote exit alerts in the same manner dictated by remote exit detection system 100. For example, if the “Yes” option of control 182j is selected, when a user picks a sensitivity level for remote exit detection system 100, local exit detection system 70 uses the same sensitivity level (or remote exit detection system 100 ignores any local exit alerts that issue that are based on a lower sensitivity level). In sum, when the “Yes” option of control 182j is selected, remote exit detection system 100 follows the user's settings—in response to both a local exit alert and/or a remote exit alert—that were entered via the remote alert settings control 182i, rather than using the settings that were entered by the local alert settings control 182h. When the “No” option is selected, remote exit detection system 100 responds to local exit alerts in the manner defined through control 182h and responds to remote exit alerts in the manner defined through control 182i (unless the user has selected the “Yes” option for control 182k, as discussed below).

Control 182k (FIG. 8) allows the user to select whether the settings and/or configuration of remote exit detection system 100 will be overridden by the same settings and/or configuration of local exit detection system 70. Thus, in those situations where both local and remote exit detection systems 70 and 100 are armed, control 182k allows the user to that remote exit detection system 100 will process both local and remote exit alerts in the manner dictated by local exit detection system 70. For example, if the “Yes” option of control 182k is selected, when a user picks a sensitivity level for local exit detection system 70, remote exit detection system 100 uses that same sensitivity level (or ignores any of its own remote exit alerts that would otherwise be issued that were based on a different sensitivity level). In sum, when the “Yes” option of control 182k is selected, remote exit detection system 100 follows the user's settings—in response to both a local exit alert and/or a remote exit alert—that were entered via the local alert settings control 182h, rather than using the settings that were entered by the remote alert settings control 182i. When the “No” option is selected, remote exit detection system 100 responds to local exit alerts in the manner defined through control 182h and responds to remote exit alerts in the manner defined through control 182i (unless the user has selected the “Yes” option for control 182j, as discussed above).

Control 182l (FIG. 8) allows the user to arm and disarm remote exit detection system 100. When the user selects the “Yes” option of control 182l, remote exit detection system 100 enters an armed state. When the user selects the “No” option of control 182l, remote exit detection system 100 enters a disarmed state. Control 182l does not affect the armed or disarmed state of local exit detection system 70.

It will be understood that the controls 182 illustrated in FIG. 8 are merely illustrative examples of the types of controls that software application 114 may present to a user. Additional controls 182, fewer controls 182, and/or different controls 182 may be presented by software application 114 in different versions of remote exit detection system 100. Such additional and/or different controls may include, but are not limited to, the following: a control that specifies that both local and remote exit detection system 100 must detect a patient exit before remote exit detection system 100 will respond; a control that specifies whether remote exit detection system 100 processes the outputs of camera units 90 and/or force sensors 54 when determining whether to issue a remote exit alert; a control that allows the user of remote exit detection system 100 to change one or more settings of local exit detection system 70 remotely; a control that allows a user to enter one or more healthcare facility protocols into remote exit detection system 100, wherein such healthcare facility protocols define the situations in which remote exit detection system 100 is to be armed and/or configured; a control to allow remote exit detection system 100 to receive data from an ADT system informing it of when patients are admitted, discharged, and/or transferred; a control allowing a user to define configurations of remote exit detection system 100 that automatically change and/or apply to different units of the healthcare facility, different work shifts, etc.; a control allowing a user to configured remote exit detection system 100 such that, if the user weighs more than a threshold, multiple caregivers are notified of an exit alert, thereby ensuring sufficient personnel are available to help move the heavier patient back into patient support apparatus 20; and still other controls.

Among the other configurations discussed herein, one or more of the controls 182 of remote exit detection system 100 allow the user to configure remote exit detection system 100 such that it only issues a remote exit alert if both the local exit detection system 70 and the remote exit detection system 100 detect a patient exit. One or more of controls 182 also allow the user to configure remote exit detection system 100 such that it issues a remote exit alert in response to either local exit detection system 70 or remote exit detection system 100 detecting a patient exit, including in situations where one of the local or remote exit detection systems 70 and 100 are disarmed. One or more controls 182 also allow the user to configure remote exit detection system 100 such that it does not issue a remote alert when remote exit detection system 100 does not detect a patient exit (whether armed or disarmed), but local exit detection system 70 does. It will also be understood, of course, that local exit detection system 70 does not issue any local exit alerts when disarmed, and that remote exit detection system 100 also does not normally issue a remote exit alert when it is disarmed, but can be configured to issue a remote exit alert while disarmed if local exit detection system 70 detects and alert and remote exit detection system 100 is configured to issue a remote alert in response to a local exit alert being detected.

In some versions of remote exit detection system 100 and/or local exit detection system 70, a patient's weight is utilized to determine how many caregivers to notify when a patient exit is detected. The patient's weight is compared to a weight threshold that may be user-defined (e.g. by an authorized individual of the healthcare facility). The weight threshold is selected to correspond to a patient weight that the healthcare facility decides is too high for a single caregiver to assist the patient back into patient support apparatus 20. In other words, some patients may be too heavy for a single caregiver to help back into patient support apparatus 20 after they exit. When local or remote exit detection systems 70 or 100 detect an exit of such a heavier patient from patient support apparatus 20, they may automatically notify multiple caregivers so that multiple caregivers will respond and be present when they help the heavier patient return to patient support apparatus 20.

In some versions, multiple weight thresholds may be implemented by local and/or remote exit detection system 70 and/or 100 for triggering a multiple-caregiver notification. In other words, if a patient weighs between X and Y pounds, then two caregivers are notified when the patient exits; if the patient weighs between Y and Z pounds, then three caregivers are notified when the patient exits; if the patient weighs even more, then four caregivers are notified, etc.

Local and/or remote exit detection system 70 and/or 100 may obtain the patient's weight from different sources. In some versions, the patient's weight is detected by force sensors 54 and shared with local and/or remote exit detection system 70 and/or 100. In other versions, the patient's weight is read from EMR server 136. In still other versions, the patient's weight may be obtained from force sensors 54, EMR server 136, and/or still other sources.

As noted, the weight threshold that triggers notification to multiple caregivers of a patient exit may be configurable by an authorized worker of the healthcare facility. In other words, local and/or remote exit detection system 70 and/or 100 may be configurable so that the healthcare facility itself decides what weight thresholds to use. In some versions, local and/or remote exit detection system 70 and/or 100 may be configurable to use different weight thresholds depending upon one of more factors, such as, but not limited to, the particular caregiver assigned to a particular patient (e.g. different weight thresholds for different caregivers); the particular time of day; the particular staffing levels of a work shift, the particular unit of the healthcare facility; and/or other factors.

In some versions, local and/or remote exit detection system 70 and/or 100 may be configured to communicate with a caregiver assignment server, or other server coupled to network 130, that informs the exit detection system 70 and/or 100 what caregivers are currently assigned to which patients. Local and/or remote exit detection system 70 and/or 100 can then use that information to implement weight thresholds that are customized to those particular caregivers. For example, a smaller and/or weaker caregiver may cause local and/or remote exit detection system 70 and/or 100 to utilize a smaller weight threshold for triggering a multi-caregiver notification than it would use for a bigger and/or stronger caregiver. This will enable the smaller and/or weaker caregiver to receive additional help from other caregivers when assisting a patient back to patient support apparatus 20. Conversely, local and/or remote exit detection system 70 and/or 100 may utilize a higher weight threshold for a stronger and/or bigger caregiver because they will be able to assist a relatively larger patient back into bed without additional help, and won't need additional assistance unless the patient exceeds a higher weight threshold. In sum, local and/or remote exit detection system 70 and/or 100 can be customized by the healthcare facility to use different weight thresholds for different caregivers, different units of the healthcare facility, different times of day, different staffing levels, etc.

In addition to, or in lieu of, a patient's weight, local and/or remote exit detection system 70 and/or 100 may be configured to notify more than one caregiver based on other conditions, such as, for example, the patient's medical state, the patient's hostility state, and/or still other conditions. Such medical conditions may be read automatically by local and/or remote exit detection system 70 and/or 100 from EMR server 136. The patient's hostility state, in some versions, may be determined by local and/or remote exit detection systems 70 and/or 100 communicating with a hostility assessment system. One example of such a hostility assessment system that may communicate with local and/or remote exit detection system 70 and/or 100 is disclosed in commonly assigned PCT patent application serial number PCT/US2024/014966 filed Feb. 8, 2024, by applicant Stryker Corporation and entitled PATIENT SUPPORT APPARATUS SYSTEM, the complete disclosure of which is incorporated herein by reference.

Remote exit detection system 100 may be configured to automatically arm itself based upon the detection of one or more triggers, and such triggers may be customized by the user. As was mentioned, in some versions, remote exit detection system 100 may automatically arm itself in response to detecting a patient in patient support apparatus 20 (through force sensors 54 and/or camera 92) and the patient having a certain fall risk assessment (or not fall risk assessment). Other triggers that may be used to determine whether to automatically arm remote exit detection system 100 include one or more sensors that are adapted to detect one or more of the patient's vital signs while in patient support apparatus 20. One example of such suitable vital sign detectors is disclosed in commonly assigned U.S. Pat. No. 7,699,784 issued to Wan Fong et al. on Apr. 20, 2010, and entitled SYSTEM FOR DETECTING AND MONITORING VITAL SIGNS, the complete disclosure of which is incorporated herein by reference.

It will be understood that remote exit detection system 100 may determine if a patient has exited using a different algorithm and/or sensors than what is used by local exit detection system 70. For example, in some versions, both local and remote exit detection system 70 and 100 utilize the outputs of force sensors 54, but they utilize them in different manners. For example, local exit detection system 70 may use the force sensor outputs to determine a center of gravity of the patient and check to see if the center of gravity is outside of a predetermined zone, while remote exit detection system 100 may use the outputs from force sensors 54—not to determine a center of gravity—but instead to determine how much the patient's weight has shifted toward the sides and/or ends of the patient support apparatus 20. Still other manners of processing the outputs of force sensors 54 may also, or alternatively, be used by either local or remote exit detection system s 70 and 100.

In another example, as was noted previously, remote exit detection system 100 may utilize the outputs of camera units 90 to determine if a patient has exited or not, instead of, or in addition to, the outputs of force sensors 54. In still other versions, remote exit detection system 100 may utilize LIDAR, UWB, RADAR, and/or other technologies to determine if a patient has exited from patient support apparatus 20. When remote exit detection system 100 is implemented using sensors that are not integrated into patient support apparatus 20 (e.g. force sensors 54), remote exit detection system 100 can be implemented on a patient support apparatus 20 that completely lacks a local exit detection system 70. In such situations, remote bed exit management system 104 oversees a single exit detection system 100. That is, remote exit detection system 100 may operate as an exit detection system for patient support apparatus(es) 20 that lack a local exit detection system 70.

In some versions of system 104, remote exit detection system 100 is adapted to be configurable by a user such that, in situations where local exit detection system 70 is disarmed while remote exit detection system 100 is armed, remote exit detection system 100 sends a command to patient support apparatus 20—in response to detecting a patient exit—that instructs patient support apparatus 20 to issue a local alert in the same manner as it would if local exit detection system 70 had been armed. In other words, remote exit detection system 100 may be configured by a user to command patient support apparatus 20 to react to a patient exit in the same manner that it would if local exit detection system 70 has been armed. In this manner, although caregiver may forget to arm local exit detection system 70, remote exit detection system 100 can command patient support apparatus 20 to behave in the same manner as if the local exit detection system 70 were armed, thereby overcoming any accidental omission by the caregiver to arm local exit detection system 70. Alternatively, remote exit detection system 100 can be configured to send a command to patient support apparatus 20 instructing it to arm local exit detection system 70. The command to arm local exit detection system 70 may be sent in response to one or more user-configurable triggers that can be implemented using configuration screen 180 or the like.

Remote exit detection system 100 may also be configured to include a pause control that is displayed on the display of any computer or computing device in communication with software app 114. The pause control, when activated by the user, pauses the remote exit alert without pausing the local exit alert. Thus, any sounds, images, and/or other notifications that would be issued by remote exit detection system 100 are paused for as long as the pause control remains active. Whatever sounds, images, and/or notifications that may be independent issued by local exit detection system 70 are not paused.

In at least one version, remote exit detection system 100 is adapted to perform the following: detect if it is in an armed or disarmed state; detect if a control 182 has been activated to respond to both local and remote exit alerts; process signals from force sensor(s) 54 and/or camera(s) 92; issue a remote exit alert if patient exits patient support apparatus 20 while remote exit detection system 100 is armed (regardless of the armed or disarmed state of local exit detection system 70); issue the remote exit alert when the patient exits patient support apparatus 20 while remote exit detection system 100 is disarmed and both of the following are true: local exit detection system 70 is armed and the control 182 has been activated to respond to both local and remote exit alerts; first state; not issue the remote alert when the patient exits patient support apparatus 20 while remote exit detection system 100 is disarmed and both of the following are true: local exit detection system 70 is armed and the third control has not been activated to respond to both local and remote exit alerts; and not issue the remote exit alert when the patient exits patient support apparatus 20 while both remote exit detection system 100 and local exit detection system 70 are disarmed.

In another version, remote exit detection system 100 is adapted to perform the following: detect if it is in an armed or disarmed state; process signals from force sensor(s) 54 and/or camera(s) 92; issue a remote exit alert if patient exits patient support apparatus 20 while remote exit detection system 100 is armed (regardless of the armed or disarmed state of local exit detection system 70); and not issue the remote alert when the patient exits patient support apparatus 20 while remote exit detection system 100 is disarmed (regardless of the armed or disarmed state of local exit detection system 70).

Patient support apparatus 20 and/or remote exit detection system 100 may also, in some versions, be configured to perform the following: detect a patient exit; receive a patient weight; compare the patient weight to a threshold; if the patient weight is less than the threshold, forward an alert message to a single caregiver; and if the patient weight is greater than the threshold, forward the alert message to a plurality of caregivers.

In some versions, remote server 110 and/or patient support apparatus 20 may be configured to communicate with a remote data repository (not shown). The remote data repository collects data regarding the usage and actions of remote bed exit management system 104. Such data includes, but is not limited to, the times at which local and/or remote exit detection systems 70 and/or 100 are armed and/or disarmed, the locations of patient support apparatuses 20 during those times, the times when either or both of exit detection system 70 and/or 100 issue exit alerts, other patient support apparatus data (e.g. whether the brake is armed, the positions of the siderails 36, the height of litter frame 28, etc.), data regarding which nursing staff was assigned to the patient when an exit alert was issued, data indicating if a patient actually exited or not (e.g. whether the exit alert was a true or false alarm), response times for the staff to respond to the exit alert, the day of the week and/or calendar day of the exit alerts, data indicating if a patient actually fell after an exit alert was issued, and/or still other data regarding patient support apparatus 20, the caregiver associated with patient support apparatus 20, the patient assigned to patient support apparatus 20 (including their diagnosis, treatment, and/or any of their EMR information), and still other data.

The remote data repository may then be used as an input to a machine learning model and/or artificial intelligence engine to gain insight into factors that may affect the time and/or frequency of patient exits. Such insights may be used to develop future algorithms or improvements to the exit detection systems 70 and/or 100 to reduce false alarms and/or better predict when patients actually exit patient support apparatus 20. The remote data repository may also be used to generate reports and/or analytics for the healthcare facility to see when patient exits are occurring and to correlate the exits and/or actual patient falls with other factors that may be influencing such exits and/or falls. Such information may be helpful to the healthcare facility in reducing patient falls and injuries. The remote data repository may receive data from patient support apparatus 20 directly, or through remote server 110. The remote data repository may also be in communication with one or more other servers of the healthcare facility, including EMR server 136, a caregiver assignment server, and ADT server, and/or still other servers.

Various additional alterations and changes beyond those already mentioned herein can be made to the above-described versions of the system described herein. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular.

What is claimed is:

1. A system for a healthcare facility comprising a patient support apparatus and a remote exit detection system, wherein the patient support apparatus comprises:
(a) a support surface adapted to support a patient thereon;
(b) a sensor adapted to detect a position of the patient;
(c) a local exit detection system adapted to be armed and disarmed; to process signals from the sensor; to issue a local alert when the patient exits the support surface while the local exit detection system is armed; and to not issue the local alert when the patient exits the support surface while the local exit detection system is disarmed;
(d) a first control adapted to arm the local exit detection system but not the remote exit detection system when activated by a user; and
(e) a transceiver adapted to transmit the signals from the sensor to the remote exit detection system;
wherein the remote exit detection system comprises a software application embodied in a non-transitory computer readable medium and adapted, when executed by a processor of a computing device, to instruct the computing device to perform the following:
(i) detect a state of a second control adapted to arm the remote exit detection system but not the local exit detection system when activated by the user;
(ii) detect a state of a third control adapted to be set by the user in a first state or a second state;
(iii) process the signals from the sensor;
(iv) issue a remote alert when the patient exits the support surface while the remote exit detection system is armed, regardless of the armed or disarmed state of the local exit detection system;
(v) issue the remote alert when the patient exits the support surface while the remote exit detection system is disarmed and both of the following are true: the local exit detection system is armed and the third control is in the first state;
(vi) not issue the remote alert when the patient exits the support surface while the remote exit detection system is disarmed and both of the following are true: the local exit detection system is armed and the third control is in the second state; and
(vii) not issue the remote alert when the patient exits the support surface while both the remote exit detection system and the local exit detection system are disarmed.

2. The system of claim 1 wherein the sensor comprises a plurality of load cells adapted to detect a weight of the patient while the patient is positioned on the support surface.

3. The system of claim 1 wherein the patient support apparatus further includes a first sensitivity control adapted to allow the user to select a first sensitivity level for the local exit detection system, and the software application is adapted, when executed by the processor of the computing device, to instruct the computing device to detect a state of a second sensitivity control, the second sensitivity control adapted to allow the user to select a second sensitivity level for the remote exit detection system, wherein the second sensitivity level may be different from the first sensitivity level.

4. The system of claim 1 wherein the local exit detection system is adapted to take into account a first set of criteria when determining whether to issue the local alert and the remote exit detection system is adapted to take into account a second set of criteria when determining whether to issue the remote alert, wherein the second set of criteria is different from the first set of criteria.

5. The system of claim 1 wherein the local alert includes at least one of the following: (1) issuing an aural sound from the patient support apparatus, or (2) flashing a light on the patient support apparatus.

6. The system of claim 1 wherein the remote alert includes at least one of the following: (1) issuing a sound from a speaker communicatively coupled to the computing device, (2) flashing an icon on a display in communication with the computing device, or (3) changing a color of the icon on the display.

7. The system of claim 1 wherein the remote exit detection system is further adapted to pause the remote alert without pausing the local alert in response to the user activating a remote pause control.

8. The system of claim 1 wherein the local exit detection system is further adapted to transmit a weight of the patient to the remote exit detection system, and the remote exit detection system is further adapted to use the weight of the patient to determine how to issue the remote alert.

9. The system of claim 8 wherein the remote exit detection system is adapted to transmit the remote alert to multiple individuals if the patient weight exceeds a threshold weight, and to transmit the remote alert to a single individual if the patient weight does not exceed the threshold weight.

10. A system for a healthcare facility comprising a patient support apparatus and a remote exit detection system, wherein the patient support apparatus comprises:
(a) a support surface adapted to support a patient thereon;
(b) a sensor adapted to detect a position of the patient;
(c) a local exit detection system adapted to be armed and disarmed; to process signals from the sensor; to issue a local alert when the patient exits the support surface while the local exit detection system is armed; and to not issue the local alert when the patient exits the support surface while the local exit detection system is disarmed;
(d) a first control adapted to arm the local exit detection system but not the remote exit detection system when activated by a user; and
(e) a transceiver adapted to transmit the signals from the sensor to the remote exit detection system;
wherein the remote exit detection system comprises a software application embodied in a non-transitory computer readable medium and adapted, when executed by a processor of a computing device, to instruct the computing device to perform the following:
(i) detect a state of a second control adapted to arm the remote exit detection system but not the local exit detection system when activated by the user;
(ii) process the signals from the sensor;
(iii) issue a remote alert when the patient exits the support surface while the remote exit detection system is armed, regardless of the armed or disarmed state of the local exit detection system; and
(iv) not issue the remote alert when the patient exits the support surface while the remote exit detection system is disarmed regardless of the armed or disarmed state of the local exit detection system.

11. The system of claim 10 wherein the sensor comprises a plurality of load cells adapted to detect a weight of the patient while the patient is positioned on the support surface.

12. The system of claim 10 wherein the patient support apparatus further includes a first sensitivity control adapted to allow the user to select a first sensitivity level for the local exit detection system, the software application is adapted, when executed by the processor of the computing device, to instruct the computing device to detect a state of a second sensitivity control, the second sensitivity control adapted to allow the user to select a second sensitivity level for the remote exit detection system, wherein the second sensitivity level may be different from the first sensitivity level.

13. The system of claim 10 wherein the local exit detection system is adapted to take into account a first set of criteria when determining whether to issue the local alert and the remote exit detection system is adapted to take into account a second set of criteria when determining whether to issue the remote alert, wherein the second set of criteria is adjustable by the user.

14. The system of claim 10 wherein the local exit detection system is adapted to take into account a first set of criteria when determining whether to issue the local alert and the remote exit detection system is adapted to take into account a second set of criteria when determining whether to issue the remote alert, wherein the second set of criteria is different from the first set of criteria.

15. The system of claim 10 wherein the local exit detection system is adapted to issue the local alert when the patient's center of gravity moves outside of a first zone and the remote exit detection system is adapted to issue the remote alert when the patient's center of gravity moves outside of a second zone different from the first zone.

16. The system of claim 10 wherein the remote exit detection system is further adapted to pause the remote alert without pausing the local alert in response to the user activating a remote pause control.

17. The system of claim 10 wherein the local exit detection system is further adapted to transmit a weight of the patient to the remote exit detection system, and the remote exit detection system is further adapted to use the weight of the patient to determine how to issue the remote alert.

18. The system of claim 17 wherein the remote exit detection system is adapted to transmit the remote alert to multiple individuals if the patient weight exceeds a threshold weight, and to transmit the remote alert to a single individual if the patient weight does not exceed the threshold weight.

19. The system of claim 10 wherein the software application is further adapted to instruct the computing device to display a dashboard screen on a display associated with the computing device, to issue the remote alert on the dashboard screen in a first manner when the remote exit detection system is armed, and to issue the remote alert on the dashboard screen in a second manner when the remote exit detection system is disarmed, the first manner being different from the second manner.

20. The system of claim 10 wherein both the local exit detection system and the remote exit detection system are adapted to calculate a center of gravity of the patient.
